(19) United States
(12) Patent Application Publication
(10) Pub. No.: US 2025/0350429 A1
(43) Pub. Date: Nov. 13, 2025

(54) METHODS, APPARATUS, AND COMPUTER PROGRAMS FOR SELECTIVELY UTILIZING DIGITAL PRE-DISTORTION COMMUNICATION NETWORK

(71) Applicant: Nokia Technologies Oy, Espoo (FI)

(72) Inventors: Feridoon JALILI, Gistrup (DK); Oana-Elena BARBU, Aalborg (DK); Martin Hedegaard NIELSEN, Aalborg (DK)

(21) Appl. No.: 19/199,686

(22) Filed: May 6, 2025

(30) Foreign Application Priority Data
May 8, 2024 (GB) 2406380.2

(51) Int. Cl. H04L 5/00; H04B 1/04

(52) U.S. Cl. CPC H04L 5/0051; H04B 1/0475; H04L 5/001

(57) ABSTRACT

This specification describes methods, apparatus, and/or computer programs for selectively utilizing digital pre-distortion in a communication network. According to a first aspect of this specification, there is described a user device including means for transmitting an uplink reference signal to a network device without using digital pre-distortion; means for receiving, from a network device, an indication indicating whether digital pre-distortion is enabled or disabled for performance, by the user device, of subsequent uplink transmissions, wherein the transmitted uplink reference signal is useable for determination of the indication; and means for, when the indication indicates that digital pre-distortion is enabled for performance of subsequent uplink transmissions, performing one or more uplink transmissions using digital pre-distortion, and when the indication indicates that digital pre-distortion is disabled for performance of subsequent uplink transmissions, performing one or more uplink transmissions without using digital pre-distortion.

### FIELD

Various example embodiments relate to apparatus, methods, and/or computer programs for selectively utilizing digital pre-distortion (DPD) in a communication network.

### BACKGROUND

Power amplifiers (PAS) used in communication networks can introduce distortion in uplink (UL) transmissions, particularly when operating above the saturation point in a nonlinear, or compression, regime. This distortion can include in-band distortion (which can be represented as, for instance, an error vector magnitude (EVM)) and out-of-band emission (which can be represented as, for instance, adjacent channel leakage power ratio (ACLR)). Techniques such as digital post distortion (DPoD) can be utilized to reduce the in-band distortion, for instance, at the receiving network device. However, since the UL transmission has already been received at the network device, the negative impact of the out-of-band emission will have already been caused.

Telecommunication networks can use frequencies ranging from 100 kHz to 300 GHz. More specifically, frequency bands for typical telecommunication networks are separated into two frequency ranges: Frequency Range 1 (FR1), which spans 410 MHz to 7125 MHz, and Frequency Range 2 (FR2), which spans 24.25 GHz to 52.6GHz. A third frequency range, Frequency Range 3 (FR3), between FR1 and FR2 (e.g., spanning 7.125 GHz to 24.25 GHz) is also sometimes used.

In higher frequency ranges (such as FR2 and upper ranges of FR3), out-of-band emission requirements can be relaxed due to the utilization of beamforming techniques. However, these beamforming techniques are not available (or practical) for use at lower frequency ranges, such as FR1 and lower ranges of FR3 (such as below 14 GHz, or below 10 GHz). Furthermore, although techniques such as digital pre-distortion (DPD) can be utilized at the user device performing the UL transmissions to reduce out-of-band emission (as well as in-band distortion), doing so can greatly increase the complexity, hardware requirements, and power consumption of these user devices in performing UL transmissions.

### SUMMARY

According to some aspects, there is provided the subject matter of the independent claims. Some further aspects are defined in the dependent claims.

For instance, in a first aspect, this specification describes a user device comprising: means for transmitting an uplink reference signal to a network device without using digital pre-distortion; means for receiving, from a network device, an indication indicating whether digital pre-distortion is enabled or disabled for performance, by the user device, of subsequent uplink transmissions, wherein the transmitted uplink reference signal is useable for determination of the indication; and means for, when the indication indicates that digital pre-distortion is enabled for performance of subsequent uplink transmissions, performing one or more uplink transmissions using digital pre-distortion, and when the indication indicates that digital pre-distortion is disabled for performance of subsequent uplink transmissions, performing one or more uplink transmissions without using digital pre-distortion.

In a second aspect, this specification describes a network device comprising: means for receiving an uplink reference signal, the uplink reference signal having been transmitted by a user device without using digital pre-distortion; means for determining, based on the received uplink reference signal, an indication indicating whether digital pre-distortion is enabled or disabled for performance, by the user device, of subsequent uplink transmissions; and means for transmitting, to the user device, the indication.

In a third aspect, this specification describes a method comprising: transmitting an uplink reference signal to a network device without using digital pre-distortion; receiving, from a network device, an indication indicating whether digital pre-distortion is enabled or disabled for performance, by the user device, of subsequent uplink transmissions, wherein the transmitted uplink reference signal is useable for determination of the indication; and when the indication indicates that digital pre-distortion is enabled for performance of subsequent uplink transmissions, performing one or more uplink transmissions using digital pre-distortion, and when the indication indicates that digital pre-distortion is disabled for performance of subsequent uplink transmissions, performing one or more uplink transmissions without using digital pre-distortion.

In a fourth aspect, this specification describes a method comprising: receiving an uplink reference signal, the uplink reference signal having been transmitted by a user device without using digital pre-distortion; determining, based on the received uplink reference signal, an indication indicating whether digital pre-distortion is enabled or disabled for performance, by the user device, of subsequent uplink transmissions; and transmitting, to the user device, the indication.

In a fifth aspect, this specification describes a user device comprising: means for transmitting, to a network device, a first uplink reference signal on a first component carrier and a second uplink reference signal on a second component carrier, wherein the first uplink reference signal and the second uplink reference signal are transmitted without using digital pre-distortion, and wherein the first component carrier and the second component carrier form part of a reception bandwidth of the network device; means for receiving, from a network device, a first indication indicating whether digital pre-distortion is enabled or disabled for performance, by the user device, of subsequent uplink transmissions on the first component carrier, wherein the transmitted first uplink reference signal is useable for determination of the first indication; means for, when the first indication indicates that digital pre-distortion is enabled for performance of subsequent uplink transmissions on the first component carrier, performing one or more uplink transmissions on the first component carrier using digital pre-distortion, and when the first indication indicates that digital pre-distortion is disabled for performance of subsequent uplink transmissions on the first component carrier, performing one or more uplink transmissions on the first component carrier without using digital pre-distortion; means for receiving, from a network device, a second indication indicating whether digital pre-distortion is enabled or disabled for performance, by the user device, of subsequent uplink transmissions on the second component carrier, wherein the transmitted second uplink reference signal is useable for determination of the second indication; and means for, when the second indication indicates that digital pre-distortion is enabled for performance of subsequent uplink transmissions on the second component carrier, performing one or more uplink transmissions on the second component carrier using digital pre-distortion, and when the second indication indicates that digital pre-distortion is disabled for performance of subsequent uplink transmissions on the second component carrier, performing one or more uplink transmissions on the second component carrier without using digital pre-distortion.

In a sixth aspect, this specification describes a network device comprising: means for receiving a first uplink reference signal on a first component carrier and a second uplink reference signal on a second component carrier, the first uplink reference signal and the second uplink reference signal having been transmitted by a user device without using digital pre-distortion, wherein the first component carrier and the second component carrier form part of a reception bandwidth of the network device; means for determining, based on the received first uplink reference signal, a first indication indicating whether digital pre-distortion is enabled or disabled for performance, by the user device, of subsequent uplink transmissions on the first component carrier; means for determining, based on the received second uplink reference signal, a second indication indicating whether digital pre-distortion is enabled or disabled for performance, by the user device, of subsequent uplink transmissions on the second component carrier; and means for transmitting, to the user device, the first indication and the second indication.

In a seventh aspect, this specification describes a method comprising: transmitting, to a network device, a first uplink reference signal on a first component carrier and a second uplink reference signal on a second component carrier, wherein the first uplink reference signal and the second uplink reference signal are transmitted without using digital pre-distortion, and wherein the first component carrier and the second component carrier form part of a reception bandwidth of the network device; receiving, from a network device, a first indication indicating whether digital pre-distortion is enabled or disabled for performance, by a user device, of subsequent uplink transmissions on the first component carrier, wherein the transmitted first uplink reference signal is useable for determination of the first indication; when the first indication indicates that digital pre-distortion is enabled for performance of subsequent uplink transmissions on the first component carrier, performing one or more uplink transmissions on the first component carrier using digital pre-distortion, and when the first indication indicates that digital pre-distortion is disabled for performance of subsequent uplink transmissions on the first component carrier, performing one or more uplink transmissions on the first component carrier without using digital pre-distortion; receiving, from a network device, a second indication indicating whether digital pre-distortion is enabled or disabled for performance, by the user device, of subsequent uplink transmissions on the second component carrier, wherein the transmitted second uplink reference signal is useable for determination of the second indication; and, when the second indication indicates that digital pre-distortion is enabled for performance of subsequent uplink transmissions on the second component carrier, performing one or more uplink transmissions on the second component carrier using digital pre-distortion, and when the second indication indicates that digital pre-distortion is disabled for performance of subsequent uplink transmissions on the second component carrier, performing one or more uplink transmissions on the second component carrier without using digital pre-distortion.

In an eighth aspect, this specification describes a method comprising: receiving a first uplink reference signal on a first component carrier and a second uplink reference signal on a second component carrier, the first uplink reference signal and the second uplink reference signal having been transmitted by a user device without using digital pre-distortion, wherein the first component carrier and the second component carrier form part of a reception bandwidth of a network device; determining, based on the received first uplink reference signal, a first indication indicating whether digital pre-distortion is enabled or disabled for performance, by the user device, of subsequent uplink transmissions on the first component carrier; determining, based on the received second uplink reference signal, a second indication indicating whether digital pre-distortion is enabled or disabled for performance, by the user device, of subsequent uplink transmissions on the second component carrier; and transmitting, to the user device, the first indication and the second indication.

In a ninth aspect, this specification describes computer-readable instructions which, when executed by a computing apparatus, cause the computing apparatus to perform (at least) any method as described herein (including the methods of the third, fourth, seventh and eighth aspects described above).

In a tenth aspect, this specification describes a computer-readable medium (such as a non-transitory computer-readable medium comprising program instructions stored thereon for performing (at least) any method described herein (including the methods of the third, fourth, seventh and eighth aspects described above).

In an eleventh aspect, this specification describes an apparatus comprising: at least one processor, and at least one memory storing instructions that, when executed by the at least one processor, causes the apparatus to perform (at least) any method as described herein (including the methods of the third and fourth aspects described above).

In a twelfth aspect, this specification describes a computer program comprising instructions which, when executed by an apparatus, cause the apparatus to perform (at least) any method as described herein (including the methods of the third, fourth, seventh and eighth aspects described above).

### BRIEF DESCRIPTION OF THE DRAWINGS

Example embodiments will now be described, by way on non-limiting examples, with reference to the following schematic drawings, in which:

FIG. 1 depicts a block diagram of an example environment that demonstrates various aspects of the present disclosure, and in which some implementations disclosed herein can be implemented;

FIG. 2 depicts a comparison of various signals with different bandwidths;

FIGS. 3A and 3B depict example scenarios involving user device channels on a reception bandwidth, in accordance with various example embodiments;

FIG. 4 depicts an example configuration for an uplink reference signal, in accordance with various example embodiments;

FIG. 5 depicts an example configuration for a plurality of uplink reference signals on corresponding component carriers, in accordance with various example embodiments;

FIG. 6 depicts procedures in accordance with various example embodiments;

FIGS. 7A and 7B are flowcharts depicting methods performed in accordance with example embodiments;

FIGS. 8A and 8B are flowcharts depicting methods performed in accordance with example embodiments;

FIG. 9 is a schematic diagram depicting components of one or more of the example embodiments described previously;

FIG. 10 depicts a tangible media for storing computer-readable code which, when run by a computer, may perform methods according to example embodiments herein.

### DETAILED DESCRIPTION

The scope of protection sought for various implementations of the subject matter disclosed herein is set out by the independent claims. The features of the subject matter described herein, if any, described in the specification that do not fall under the scope of the independent claims are to be interpreted as examples useful for understanding various implementations of the subject matter described herein.

In the description and drawings, like reference numerals refer to like elements throughout.

In the following, different exemplifying embodiments will be described using, as an example of a communication network, a sixth generation (6G) communication network, without restricting the embodiments to such an architecture. It will be appreciated that the embodiments described herein may also be applied to other kinds of communications networks having suitable means by adjusting parameters and procedures appropriately, such as new radio (NR), fifth generation (5G) or 5G-Advanced communication network, or other future communication network technologies. Some examples of other options for suitable systems are the universal mobile telecommunications system (UMTS) radio access (UTRA), long term evolution (LTE, also known as E-UTRA), long term evolution advanced (LTE Advanced, LTE-A), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

In addition, in the following, the term user device typically refers to a portable computing device that include wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, multimedia device, aerial/terrestrial/maritime vehicle, etc. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over the IoT network without requiring human-to-human or human-to-computer interaction. In some applications, a user device may comprise a small portable device with radio parts (such as a watch, earphones or eyeglasses) whereby some or all computation is carried out in the cloud. A user device may also be called a UE, a terminal device, a subscriber unit, mobile station, remote terminal, access terminal, or user terminal just to mention but a few names or apparatuses.

In certain situations (e.g., to increase coverage), user devices in a communication network (e.g., a 6G, or 5G communication network) can be given permission to operate PAs in a compression (or, in other words, non-linear) regime. However, this can lead to degradation in both EVM (or otherwise referred to as in-band distortion) and ACLR (or otherwise referred to as out-of-band emission).

EVM is a measure of the difference between the reference waveform and the measured waveform. This difference can be referred to as the error vector. Before determining the EVM, the measured waveform can be corrected by a sample timing offset and a radio frequency (RF) frequency offset, and a carrier leakage can be removed from the measured waveform. The measured waveform can also be further equalized using channel estimates, where the channel estimates can be subjected to a EVM equalizer spectrum flatness requirement (e.g., as defined in an appropriate standard). In some implementations (e.g., for discrete Fourier transform-spread-orthogonal frequency division multiplexing (DFT-S-OFDM) waveforms), the EVM result can be defined after a front-end fast Fourier transform (FFT) and inverse discrete Fourier transform (IDFT) as the square root of the ratio of the mean error vector power to the mean reference power expressed as a %. In some implementations, (e.g., for cyclic prefix OFDM (CP-OFDM) waveforms), the EVM result can be defined after the front-end FFT as the square root of the ratio of the mean error vector power to the mean reference power expressed as a %. EVM can generally be expected to increase when the user device enhances its modulation scheme. In addition, EVM can be expected to increase with a lower modulation scheme if the user device also operates PAs in saturation to achieve higher power efficiency and lower supply current.

In some implementations, the basic EVM measurement interval in the time domain can be one preamble sequence for the physical random access channel (PRACH), and one slot for physical uplink control channel (PUCCH) and physical uplink shared channel (PUSCH) in the time domain. The EVM measurement interval can be reduced by any symbols that contain an allowable power transient in the measurement interval (e.g., as defined in the appropriate standard).

Some communication networks can define requirements for the EVM (e.g., a maximum threshold EVM). For instance, it can be defined that the root mean square (RMS) average of the basic EVM measurements (over 10 subframes for the average EVM case, and over 60 subframes for the reference signal EVM case) shall not exceed threshold values. In some implementations, the threshold values can be based on the modulation scheme used (e.g., because the simpler the modulation scheme, the more robust demodulation of the received signal can be to noise and/or distortion). For instance, when the modulation scheme is Pi/2-binary phase shift keying (BPSK), the threshold value for the average EVM level can be 30%. When the modulation scheme is quadrature phase shift keying (QPSK), the threshold value for the average EVM level can be 17.5%. When the modulation scheme is 16 quadrature amplitude modulation (QAM), the threshold value for the average EVM level can be 12.5%. When the modulation scheme is 64 QAM, the threshold value for the average EVM level can be 8%. When the modulation scheme is 256 QAM, the threshold value for the average EVM level can be 3.5%.

ACLR is the ratio of the filtered mean power centred on the assigned channel frequency to the filtered mean power centred on an adjacent channel frequency. NR Adjacent Channel Leakage Power Ratio (NRACLR) is the ratio of the filtered mean power centred on the assigned NR channel frequency to the filtered mean power centred on an adjacent NR channel frequency at nominal channel spacing. The assigned NR channel power and adjacent NR channel power are measured with rectangular filters with measurement bandwidths (e.g., as defined in the appropriate standard). UTRA adjacent channel leakage power ratio (UTRAACLR) is the ratio of the filtered mean power centred on the assigned NR channel frequency to the filtered mean power centred on an adjacent(s) UTRA channel frequency.

Some communication networks can define requirements for the ACLR (e.g., a maximum ACLR threshold). For instance, some communication networks can define that if the measured adjacent channel power is greater than −50 dBm then the ACLR shall be higher than a threshold value (e.g., 37 dB, 31 dB, 30 dB, etc., for instance as defined in the appropriate standard).

In some cases, EVM degradation introduced by operating UL PAs in a compression regime can be mitigated at the network side (e.g., at a network device such as a gNB). This can allow the PAs to operate at a higher power (e.g., and thus increasing coverage), and/or allow for maximum power reduction (MPR) to be relaxed. However, as mentioned, operating a PA at a higher compression will also increase the ACLR. In some situations, for instance when operating in FR2, ACLR requirements can be relaxed (e.g., because beamforming techniques can be utilized), meaning that the increased ACLR is less problematic. However, in many situations, for instance, when operating in FR1, or in lower ranges of FR3, beamforming techniques are not possible, or at least not practical.

As such, in many situations (e.g., when operating in FR1, or in lower ranges of FR3), in order to prevent any negative impacts to the performance of communication networks as a result of the increased ACLR (e.g., unsuccessful delivery of UL transmissions), the user device may not be allowed to violate certain, more strict, ACLR requirements. In some cases, this can lead to large power back-offs being enforced on the UL PAs, reducing the effective coverage of the user devices, although this can be mitigated somewhat through various techniques. For instance, in 5G and generations before, user devices are allowed to reduce the maximum output power due to higher order modulations and transmit bandwidth configuration to meet transmission requirements such as out-of-band-emission (ACLR) or in-band emission (EVM). Alternatively or additionally, the user device can utilize linearization procedures, such as DPD or envelope tracking, to compensate for non-linear distortion introduced by PAs. Such linearization techniques can improve both EVM and ACLR. However, these techniques are relatively complicated and increase the hardware requirements of user devices, as well as current consumption (and therefore power consumption) of user devices. One technique to mitigate the distortion without increasing current consumption at the user device is to use digital post distortion (DPoD) at the network side. More specifically, DPoD can be used to mitigate the EVM. However, DPoD cannot improve the out-of-band emission since the violation of ACLR will have already occurred. Furthermore, a network device cannot be aware of a user device's ACLR violation while the user device is relaxing the MPR or running the PA in high compression to get the benefit of DPoD.

As such, implementations described herein provide a mechanism to enable communication networks to prevent user devices from violating ACLR, thereby mitigating the challenges posed by PA nonlinearities in these communication networks. Implementations described herein also provide a mechanism to enable communication networks to prevent user devices from violating ACLR when operating in FR1 or in lower ranges of FR3. Implementations described herein also relate to selectively using DPD (and optionally DPoD) for improving uplink efficiency.

More specifically, implementations described herein relate to a new signalling procedure between a user device and a network device, where information about the user device's transmission spectrum is provided to the network device in a controlled manner, without violating ACLR. For instance, in some implementations, after an initial connection procedure, the network device can make an observation of the user device's transmission spectrum and signal the ACLR level back to the user device (e.g., by signalling to the user device to transmit a reference signal using the minimum channel bandwidth (BW) in inner resource blocks during one slot time). Furthermore, in some implementations, when DPD is inactive and the network device (or the user device) decides to increase the user device's UL transmission power or when DPD is active and the network device (or the user device) decides to decrease the user device's UL transmission power, the network device can make another observation of the user device's transmission spectrum and signal the ACLR level back to user device (e.g., by signalling to the user device to transmit another reference signal using the minimum channel BW in inner resource blocks during one slot time). Consequently, the user device can dynamically activate DPD if an ACLR violation is detected (optionally on top of DPoD at the network device, which may be parameter based or machine-learning based) whenever needed. In other words, the user device can avoid activation of DPD if it is not necessary. In this way, the user device can transmit with higher EVM while keeping the ACLR within output spectrum emission requirements. This proactive approach can ensure optimized and efficient communication in terms of EVM and ACLR.

Furthermore, the reference signal can be configured (e.g., by using the lowest BW of the operating channel bandwidth and placing the uplink transmission in the middle of the operating channel) to ensure that transmission of the reference signal will cause, at worst, a short violation of ACLR (in one slot) as an in-channel distortion for the actual network device-supported band and there will be no violation to adjacent channels which may belong to another network or network device. In addition, the reference signal can be configured (e.g., by using the lowest BW of the operating channel bandwidth and placing the uplink transmission in the middle of the operating channel) to ensure that the ACLR can be measured within a reception bandwidth of the network device, meaning that additional hardware at the network device is not required to measure the ACLR.

Moreover, implementations described herein utilize a correlation between narrowband and wideband to create a new signal to make the user device aware of possible spectrum violations before full spectrum allocation. In this way, a DPD and DPoD effect can be applied before adjacent channels are truly violated.

In these and other manners, implementations described herein can allow for efficient network scheduling between capacity and coverage. For instance, in some implementations, the network device can be configured to prioritize capacity by allocating higher BW and modulation schemes whilst keeping the user device's uplink transmission power unchanged to relax the user device's use of its own DPD. In some situations, the network device can decide to increase coverage, which may or may not result in DPD being activated at the user device. This dynamic activation/deactivation approach can give the user device a significant current (or in other words, power) consumption reduction opportunity.

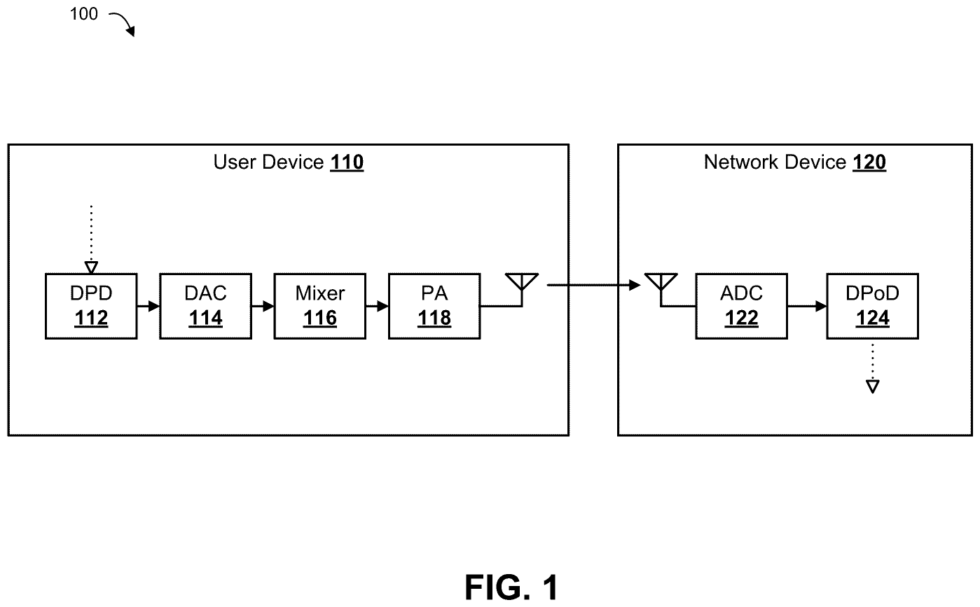

Turning to FIG. 1, a block diagram of an example environment 100 that demonstrates various aspects of the present disclosure is depicted. As illustrated in FIG. 1, the example environment 100 includes a user device 110 and a network device 120. Although, example environment 100 is shown as including a single user device 110 and a single network device 120, it will be appreciated that in various implementations, any number of user devices and network devices may be used. Furthermore, although the user device 110 and the network device 120 are shown as including a number of sub-systems, it will be appreciated that in various implementations, some, all, or none of the sub-systems may be included, and that in various implementations, other sub-systems not described herein may be included.

As illustrated in example environment 100, and with respect to the uplink direction of communication, the user device 110 can include a digital pre-distortion subsystem 112, a digital to analogue converter (DAC) sub-system 114, a mixer sub-system 116, a power amplifier sub-system 118, and one or more corresponding antenna(s) or antenna array(s). As described herein, when selectively activated, the digital pre-distortion (DPD) sub-system 112 can process digital information to be transmitted by the user device 110. The DPD sub-system 112 can perform DPD to eliminate, or at least minimize, distortion introduced by the power amplifier (PA) subsystem 118, particularly when the PA subsystem 118 is operating in a saturation regime, as described in more detail herein. The DAC sub-system 114 can convert the digital information into analogue signals (e.g., radio frequency (RF) wireless communication signals). The mixer sub-system 116 can process the analogue signals output by the DAC sub-system 114. The mixer sub-system 116 can, for instance, modulate a carrier signal using the analogue signals from the DAC sub-system 114. The form of modulation can be of any suitable type (e.g., binary phase-shift keying (BPSK), quadrature phase-shift keying (QPSK), 16 quadrature amplitude modulation (QAM), 64 QAM, 256 QAM, etc.), and can be selected at any given time based on a number of environmental factors. The PA sub-system 118 can amplify the output of the mixer subsystem 116 for transmission, via the one or more antenna(s) or array(s), to the network device 120. The gain of the PA subsystem(s) 118 can be determined based on various factors, such as the distance between the user device 110 and the network device 120.

In some implementations, the user device 110 can be configured to provide uplink (UL) transmissions to the network device 120 on a plurality of UL carriers (or in other words, UL component carriers (CCs)) in parallel, enabling carrier aggregation (CA). Since each CC will have specific characteristics (e.g., in terms of coverage and capacity), the gain requirements for each CC at any given time will be specific to that CC. As such, in some implementations, the user device 110 can include a plurality of PA sub-systems corresponding to a plurality of carriers (or CCs). Furthermore, since the distortion introduced by a given PA sub-system can be specific to that PA sub-system, DPD, when required, must be performed in respect of each PA sub-system individually. As such, the user device 110 can include a plurality of DPD sub-systems 112 corresponding to the plurality of PA sub-systems 118. As a result, although in FIG. 1, the user device 110 is shown as including only a single set of sub-systems, in some implementations, the user device 110 can include a plurality of sets of sub-systems.

As further illustrated in example environment 100, the network device 120 can include one or more antenna(s) or array(s), an analogue to digital converter (ADC) sub-system 122, and a digital post-distortion (DPoD) sub-system 124. The network device 120 can, for instance, include any component, or part thereof, of a cellular network. For instance, the network device 120 can include a gNodeB (gNB), an eNodeB (eNB), a base station, etc. The network device 120 can receive, via the one or more antenna(s) or array(s), UL transmissions from the user device 110. The ADC sub-system 122 can convert the received analogue signals into digital information, which can be further processed. The DPoD sub-system 124, when activated, can process the output from the ADC sub-system 122. For instance, the DPoD sub-system 124 can perform DPoD to compensate for distortion (e.g., EVM) introduced by the PA subsystem 118, particularly when the PA sub-system 118 is operating in the saturation mode.

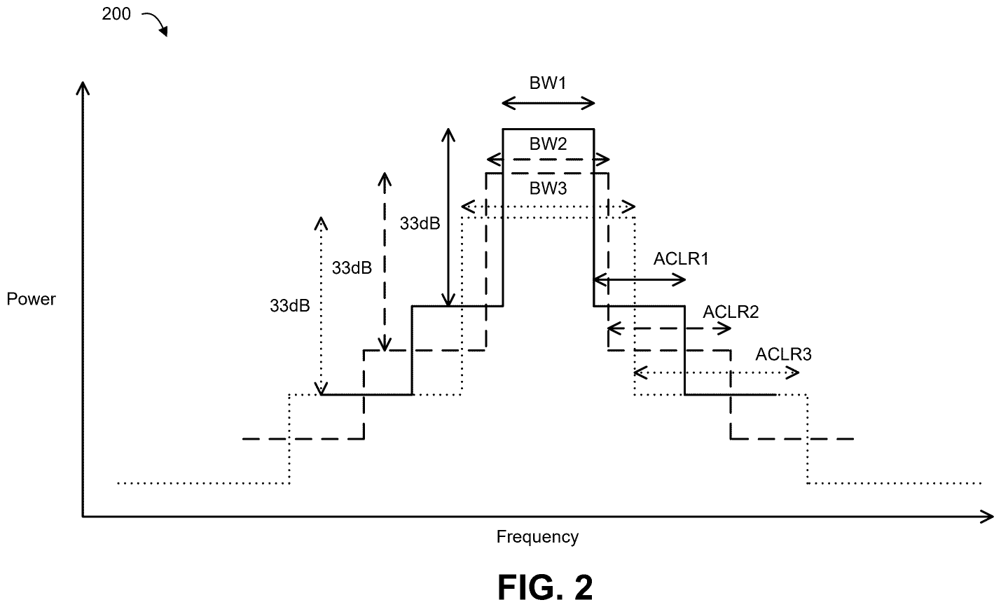

Implementations described herein relate to the use of a reference signal, transmitted by the user device 110 to the network device 120, to determine whether or not DPD should be activated at the user device 110 (e.g., using the one or more DPD sub-system(s) 112). For instance, the reference signal can be configured in such a way that the network device 120 can determine an ACLR of the user device 110 based on the reference signal, without risk of violating adjacent channels. This can be as a result of a configuration of the bandwidth and location of the reference signal. For instance, the reference signal can be configured to use a narrow bandwidth or bandwidth part (BWP) (e.g., the narrowest bandwidth that the user device 110 can operate). The network device 120 can then detect the transmission spectrum based on the narrow bandwidth and determine whether there is a ACLR violation (e.g., when the ACLR exceeds an ACLR threshold) or not for the narrow bandwidth. The network device 120 can extrapolate this to determine whether there would be an ACLR violation or not for wider bandwidths. This is based on the principle that ACLR measurements for narrower bandwidths from a given transmitter system (including a given PA sub-system) are equally applicable to wider bandwidths for the same transmitter system, given a constant channel power. This principle is further described in relation to FIG. 2.

Turning to FIG. 2, a comparison 200 of various signals with different bandwidths is depicted. In particular, the comparison 200 includes a first signal with a first bandwidth BW1, a second signal with a second bandwidth BW2, and a third signal with a third bandwidth BW3. The second bandwidth BW2 is wider than the first bandwidth BW1. The third bandwidth BW3 is wider than the second bandwidth BW2. Furthermore, the first signal has an adjacent channel ACLR1 either side of the first bandwidth BW1 and with a same bandwidth as the first bandwidth BW1. The second signal has an adjacent channel ACLR2 either side of the second bandwidth BW2 and with a same bandwidth as the second bandwidth BW2. The third signal has an adjacent channel ACLR3 either side of the third bandwidth BW3 and with a same bandwidth as the third bandwidth BW3. Each of the first signal, the second signal, and the third signal have a constant channel power.

As illustrated in FIG. 2, with a constant channel power, while extending the bandwidth from the first signal to the second signal and from the second signal to the third signal, the relative level of channel power to the adjacent channel (e.g., 33 dB) is unchanged. In other words, even though the bandwidths of the adjacent channels ACLR1 of the first signal is narrower than the bandwidths of the adjacent channels ACLR2 of the second signal, since the average power in the adjacent channels ACLR2 of the second signal is lower than the average power in the adjacent channels ACLR1 of the first channel, the channel power of the adjacent channels ACLR1 of the first signal and of the adjacent channels ACLR2 of the second signal can be the same. Similarly, even though the bandwidths of the adjacent channels ACLR2 of the second signal is narrower than the bandwidths of the adjacent channels ACLR3 of the third signal, since the average power in the adjacent channels ACLR3 of the third signal is lower than the average power in the adjacent channels ACLR2 of the second channel, the channel power of the adjacent channels ACLR2 of the second signal and of the adjacent channels ACLR3 of the third signal can be the same. As such, detection of the spectrum by the network device based on the first signal would provide information as to whether the ACLR limit (or threshold) would be violated or not for the wider bandwidths of the second and third signals as well.

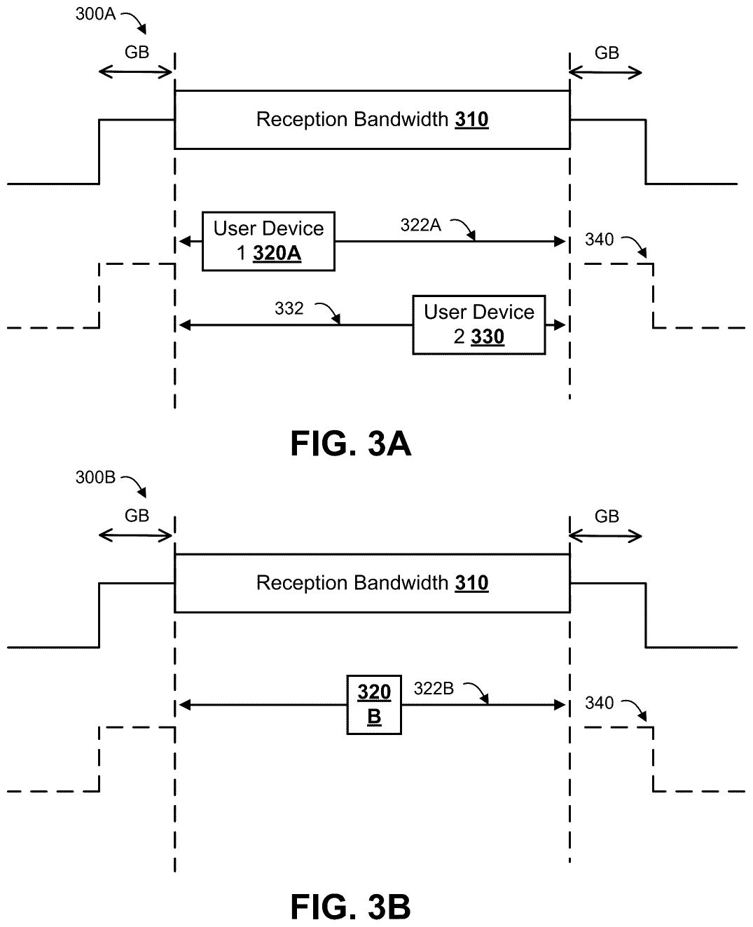

Turning to FIG. 3A, an example scenario 300A involving user device channels on a reception bandwidth in accordance with various example embodiments is depicted. As illustrated in FIG. 3A, a network device (which may be similar to, for instance, the network device 120 of FIG. 1), can provide a channel bandwidth, including a reception bandwidth 310 and guard bands GB adjacent to the reception bandwidth 310 (otherwise referred to as, for instance, a network device channel, a network device operating channel, etc.). A first channel 320A within the reception channel 310 can be allocated for a first user device (which may be similar to, for instance, the user device 110 of FIG. 1). A second channel 330 within the reception bandwidth 310 can be allocated for a second user device (which may be similar to, for instance, the user device 110 of FIG. 1). Although example scenario 300A refers to a first channel 320A and a second channel 330, it will be appreciated that any number of channels can be allocated for corresponding user devices. The first user device can provide a first in-band emission 322A, and the second user device can provide a second in-band emission 332. An out-of-band emission mask 340 (e.g., the frequency spectra outside the reception BW) can also be used for all of the user devices.

Out-of-band emission (e.g., ACLR) requirements can be configured to be the same for all of the user devices (e.g., in this case, the first user device and the second user device). However, user devices with channels placed closer to the centre of the reception bandwidth can contribute less to out-of-band emission relative to channels placed closer to an upper or lower edge of the reception bandwidth. For instance, in example scenario 300A, the contribution from the first user device to the left side of the out of band emission mask 340 will be higher than the contribution to the of the second user device. Similarly, the second user device will have a greater contribution to the right side of the out of band emission mask 340.

Turning to FIG. 3B, an example scenario 300B involving user device channels on a reception bandwidth in accordance with various example embodiments is depicted. The example scenario 300B can be similar to example scenario 300A, however, whilst example scenario 300A can illustrate a situation in which a connection between the user devices and the network device has already been established, example scenario 300B can illustrate a situation in which the network device is conducting spectrum detection (e.g., to make an observation as to whether a user device will violate ACLR requirements at a given UL transmission power).

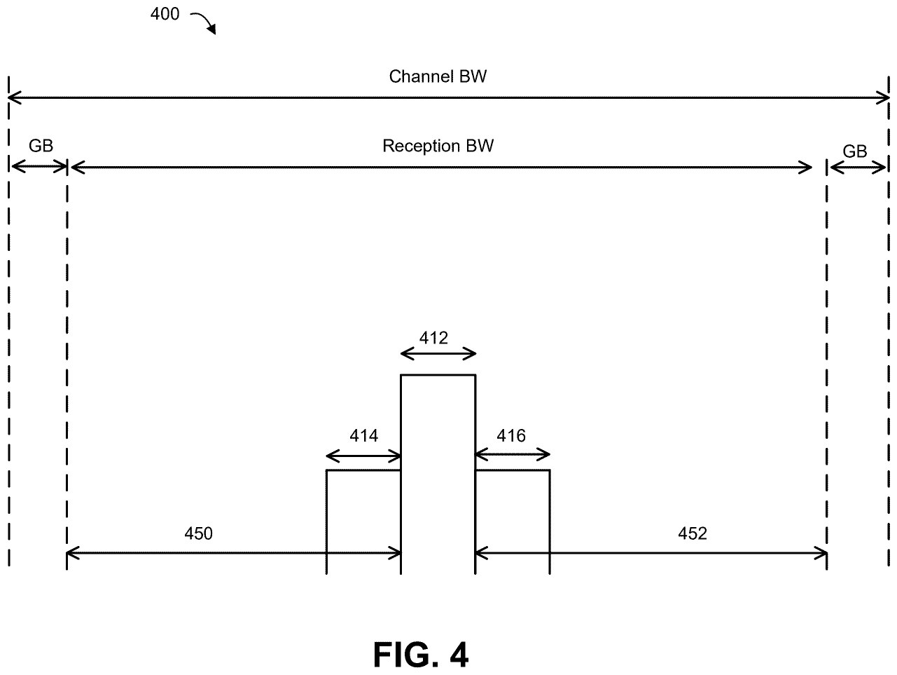

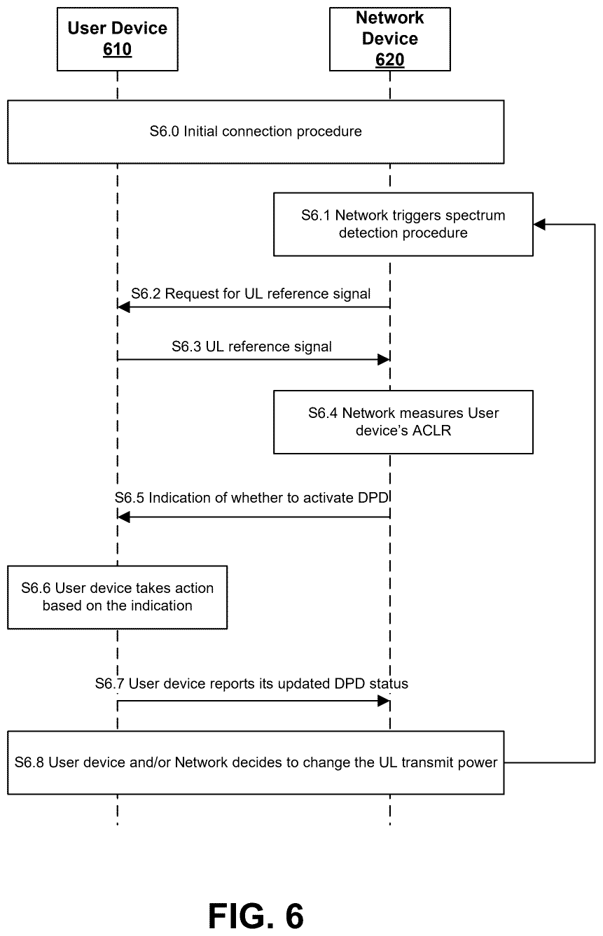

As shown in example scenario 300B, during spectrum detection (e.g., as described in more detail in FIG. 4, and FIG. 6), the first user device can be allocated with a first channel 320B. The first channel can be configured to be relatively narrow and located relatively centrally in the reception bandwidth 310. The first user device can thus provide in-band emission 322B, and the contribution of the first user device to the out-of-band emission mask 340 can be negligible.

In some implementations, the first user device can be allocated with the narrowest channel possible for the user device. For instance, the first user device can be allocated with the narrowest bandwidth part (BWP) available to the user device. BWPs are a set of continuous physical resource blocks (PRBs) of given numerology and given cyclic prefix on a network carrier. For instance, according to the NR standard, for a largest FFT size of 4 k, a max BWP can be 400 MHz with 120 kHz sub carrier spacing (SCS) and 275 PRBs. Furthermore, NR supports 4 numerologies {15, 30, 60KHz} SCS in FR1 and {60,120 KHz} in FR2; and BWP sizes between 24 and 275 PRB. Also in NR, user devices support a minimum BW of 100 MHz in FR1 (<6 GHZ) and 200 MHz in FR2 (>6 GHz).

Turning to FIG. 4, an example configuration 400 for an uplink reference signal, in accordance with various example embodiments, is depicted. Similarly to FIGS. 3A and 3B, as illustrated in FIG. 4, a network device (e.g., which may be similar to the network device 120 of FIG. 1) can provide a channel BW. The channel BW can include a reception BW, and guard bands GB adjacent a lower and upper edge of the reception BW.

As illustrated in FIG. 4, the uplink reference signal can be configured so as to be usable for determining whether or not DPD should be activated at a user device for performance of subsequent uplink transmissions. More specifically, a frequency portion 412 in which the uplink reference signal is transmitted can be configured so that the uplink reference signal is usable for determining whether or not DPD should be activated at a user device for performance of subsequent uplink transmissions.

As further shown in FIG. 4, the BW of the adjacent channels 414, 416 to the frequency portion 412, over which the ACLR can be characterized, may have the same BW as the frequency portion 412. For instance, the BW of the adjacent channel 414 to the lower edge of the frequency portion 412 can be equal to the BW of the frequency portion 412. Similarly the BW of the adjacent channel 416 to an upper edge of the frequency portion 412 can be equal to the BW of the frequency portion 412. As described herein, in many implementations, the ACLR is characterized based on the first adjacent channels 414, 416, since it can be assumed that out-of-band emission in further adjacent channels is negligible. As such, in order to characterize the ACLR of the user device within the reception bandwidth, the adjacent channels 414, 416 must not fall outside the reception BW. As illustrated in FIG. 4, this can be enforced by configuring a specific width and location of the frequency portion 412 in which the uplink reference signal is transmitted. Put another way, the width and location of the frequency portion 412 can be tailored so as to allow the network device to characterize an ACLR of the user device within the reception BW. In particular, the frequency portion 412 can be configured such that a difference 450 between a lower edge of the frequency portion 412 and a lower edge of the reception BW is greater than or equal to a width of the frequency portion 412 (e.g., the width of the adjacent channel 414 to a lower edge of the frequency portion 412), and that a difference 452 between an upper edge of the frequency portion 412 and an upper edge of the reception BW is greater than or equal to a width of the frequency portion 412 (e.g., the width of the adjacent channel 416 to the upper edge of the frequency portion 412).

As described herein, the frequency portion 412 can correspond to an uplink BWP. The uplink BWP can be configured so as to span a minimum allowed number of RPRBs. Furthermore the frequency portion 412 can be configured to be located at a central position (e.g., substantially at the centre of the reception BW, within a threshold frequency of the centre of the reception BW, etc.).

In this way, it can be determined whether or not to activate DPD at the user device for performance of subsequent UL transmission (e.g., by characterizing the ACLR of the user device in the reception BW), whilst minimising the impact of an ACLR violation on neighbouring channels.

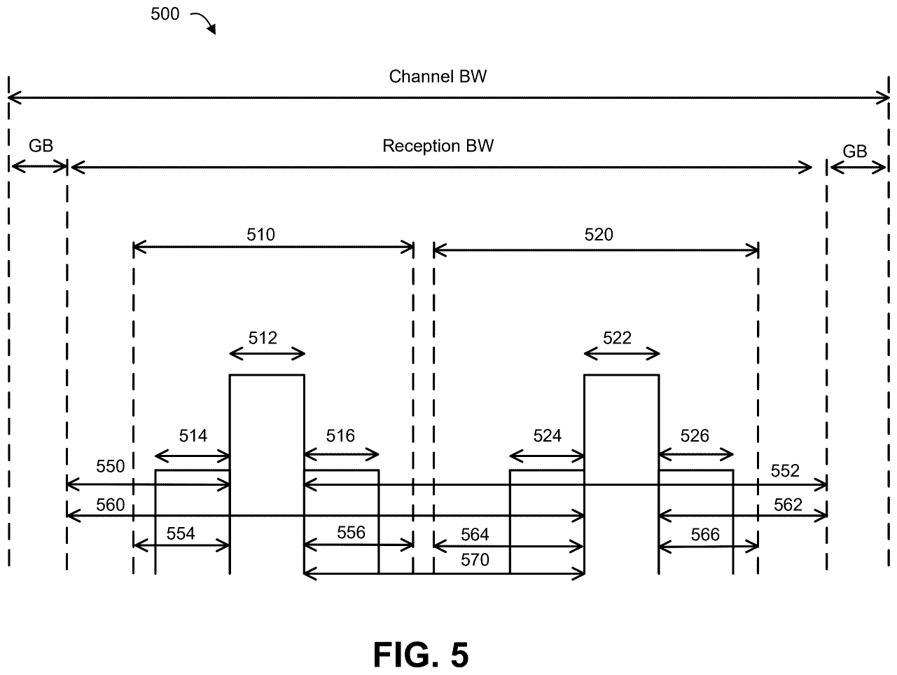

Although implementations have generally been described in relation to determining whether the user device should activate DPD for UL transmissions on a single carrier (e.g., using a single UL reference signal), in some implementations, the techniques described herein can be used in a carrier aggregation (CA) (e.g., intra-band contiguous CA). More specifically, in some implementations, it can be determined whether DPD should be activated for performance of UL transmissions on a plurality of component carriers (CCs) (e.g., using a plurality of corresponding UL reference signals), as described in more detail in FIG. 5.

Turning to FIG. 5, an example configuration 500 for a plurality of uplink reference signals on corresponding component carriers (CCs), in accordance with various example embodiments is depicted. Similarly to FIGS. 3A and 3B and FIG. 4, a network device (e.g., which may be similar to the network device 120 of FIG. 1) can provide a channel BW. The channel BW can include a reception BW, and guard bands GB adjacent a lower and upper edge of the reception BW. Although FIG. 5 shows a first uplink reference signal transmitted on a first CC 510, and a second uplink reference signal transmitted on a second CC 520, it will be appreciated that any number of reference signals on corresponding CCs can be configured.

As illustrated in FIG. 5, the first uplink reference signal on the first CC 510 can be configured so as to be usable for determining whether or not DPD should be activated at a user device for performance of subsequent uplink transmissions on the first CC 510. More specifically, a first frequency portion 512 in which the first uplink reference signal is transmitted can be configured so that the first uplink reference signal is usable for determining whether or not DPD should be activated at a user device for performance of subsequent uplink transmissions on the first CC 510. Similarly, the second uplink reference signal on the second CC 520 can be configured so as to be usable for determining whether or not DPD should be activated at a user device for performance of subsequent uplink transmissions on the second CC 520. More specifically, a second frequency portion 522 in which the second uplink reference signal is transmitted can be configured so that the second uplink reference signal is usable for determining whether or not DPD should be activated at a user device for performance of subsequent uplink transmissions on the second CC 520.

As further shown in FIG. 5, the BW of the adjacent channels 514, 516 to the first frequency portion 512, over which a first ACLR can be characterized (e.g., an ACLR corresponding to the first CC 510), may have the same BW as the first frequency portion 512. For instance, the BW of the adjacent channel 514 to the lower edge of the first frequency portion 512 can be equal to the BW of the first frequency portion 512. Similarly the BW of the adjacent channel 516 to an upper edge of the first frequency portion 512 can be equal to the BW of the first frequency portion 512. As such, in order to characterize the ACLR of the user device within the reception bandwidth, the adjacent channels 514, 516 must not fall outside the reception BW. This can be enforced by configuring a specific width and location of the first frequency portion 512 in which the first uplink reference signal is transmitted. Put another way, the width and location of the first frequency portion 512 can be tailored so as to allow the network device to characterize an ACLR of the user device within the reception BW. In particular, the first frequency portion 512 can be configured such that a difference 550 between a lower edge of the first frequency portion 512 and a lower edge of the reception BW is greater than or equal to a width of the first frequency portion 512 (e.g., the width of the adjacent channel 514 to a lower edge of the first frequency portion 512), and that a difference 552 between an upper edge of the first frequency portion 512 and an upper edge of the reception BW is greater than or equal to a width of the first frequency portion 512 (e.g., the width of the adjacent channel 516 to the upper edge of the first frequency portion 512).

Similarly, the BW of the adjacent channels 524, 526 to the second frequency portion 522, over which a second ACLR can be characterized (e.g., an ACLR corresponding to the second CC 520), may have the same BW as the second frequency portion 522. For instance, the BW of the adjacent channel 524 to the lower edge of the second frequency portion 522 can be equal to the BW of the second frequency portion 522. Similarly the BW of the adjacent channel 526 to an upper edge of the second frequency portion 522 can be equal to the BW of the second frequency portion 522. As such, in order to characterize the ACLR of the user device within the reception bandwidth, the adjacent channels 524, 526 must not fall outside the reception BW. This can be enforced by configuring a specific width and location of the second frequency portion 522 in which the second uplink reference signal is transmitted. Put another way, the width and location of the second frequency portion 522 can be tailored so as to allow the network device to characterize an ACLR of the user device within the reception BW. In particular, the second frequency portion 522 can be configured such that a difference 560 between a lower edge of the second frequency portion 522 and a lower edge of the reception BW is greater than or equal to a width of the second frequency portion 522 (e.g., the width of the adjacent channel 524 to a lower edge of the second frequency portion 522), and that a difference 562 between an upper edge of the second frequency portion 522 and an upper edge of the reception BW is greater than or equal to a width of the second frequency portion 522 (e.g., the width of the adjacent channel 526 to the upper edge of the second frequency portion 522).

In some implementations, the ACLR of the UL reference signals can be determined within the respective CCs (e.g., to minimise the impact of ACLR violations on neighbouring CCs). For instance, the first frequency portion 512 can be configured such that a difference 554 between a lower edge of the first frequency portion 512 and a lower edge of the first CC 510 is greater than or equal to a width of the first frequency portion 512 (e.g., the width of the adjacent channel 514 to a lower edge of the first frequency portion 512), and that a difference 556 between an upper edge of the first frequency portion 512 and an upper edge of the first CC 510 is greater than or equal to a width of the first frequency portion 512 (e.g., the width of the adjacent channel 516 to the upper edge of the first frequency portion 512). Similarly, the second frequency portion 522 can be configured such that a difference 564 between a lower edge of the second frequency portion 522 and a lower edge of the second CC 520 is greater than or equal to a width of the second frequency portion 522 (e.g., the width of the adjacent channel 524 to a lower edge of the second frequency portion 522), and that a difference 566 between an upper edge of the second frequency portion 522 and an upper edge of the second CC 520 is greater than or equal to a width of the second frequency portion 522 (e.g., the width of the adjacent channel 526 to the upper edge of the second frequency portion 522).

Additionally or alternatively, the UL reference signals can be configured to avoid interfering with one another. For instance, the first frequency portion 512 and the second frequency portion 522 can be configured such that a difference 570 between the upper edge of the first frequency portion 512 and the lower edge of the second frequency portion 510 is greater than or equal to a width of both the first frequency portion 512 and the second frequency portion 522 (e.g., the width of both the adjacent channel 514 to the upper edge of the first frequency portion 512 and the adjacent channel 524 to the lower edge of the second frequency portion 522).

As described herein, the first frequency portion 512 can correspond to a first uplink BWP and the second frequency portion 522 can correspond to a second uplink BWP. The first and second uplink BWPs can be configured so as to span a minimum allowed number of RPRBs. Furthermore, in some implementations, the frequency portions 512 and 522 can be configured to be located at central positions of the respective CCs.

Turning to FIG. 6, procedures which can be performed in accordance with various example embodiments are depicted. One or more of the procedures of FIG. 6 can be performed by a user device 610, which may be the same or similar to the user device as described in relation to any one of the preceding FIGs (e.g., user device 110 of FIG. 1). Furthermore, one or more of the procedures of FIG. 6 can be performed by a network device 620 which can be the same or similar to the network device described in relation to any of the preceding FIGs (e.g., network device 120 of FIG. 1).

The procedures of FIG. 6 can, for instance, provide the necessary signalling to facilitate selective activation of DPD at the user device 610 for UL transmissions. This can be facilitated by configuring a UL reference signal to be usable to make the decision as to whether to activate DPD at the user device 610, and making appropriate observations (e.g., by characterizing the ACLR of the user device 610 based on the UL reference signal). In this way, UL coverage of the user device 610 can be improved whilst meeting ACLR requirements, and current consumption from unnecessary use of DPD for UL transmissions can be minimised.

At operation S6.0, the user device 610 and the network device 620 can perform an initial connection procedure. For instance, the initial configuration procedure can include one or more stages of a typical initial connection procedure up to including PDU session establishment. Furthermore, as part of the initial connection procedure, the user device 610 can transition from an open loop power control to a closed loop power control. Additionally or alternatively, the initial connection procedure can include the network device 620 requesting the user device for a DPD status (e.g., whether DPD is currently activated for UL transmission) and/or a DPD capability (e.g., whether DPD can be activated for UL transmission). Additionally or alternatively, the initial connection procedure can include the user device 610 reporting a DPD status and/or DPD capability (e.g., responsive to a request from the network device 620). Additionally or alternatively, the initial connection procedure can include the network device 620 activating DPoD at the network device 620, and in some implementations, reporting that DPoD is activated at the network device 620 to the user device 610.

At operation S6.1, the network device 620 triggers a spectrum detection procedure. The spectrum detection procedure can enable to network device 620 to characterize (e.g., determine, calculate, measure, etc.) out-of-band emission (e.g., ACLR) of the user device's 610 transmitter spectrum. The spectrum detection procedure can include configuring a UL reference signal. For instance, the network device 620 can determine configuration information for the UL reference signal, including one or more of a BW or BWP in which the UL reference signal is confined, UL transmit power control information, a carrier (e.g., a location in the reception BW), etc. In some implementations, the configuration information can additionally or alternatively include a code for the UL reference signal (e.g., Gold code, Zadoff-Chu sequence, or any other known sequence of modulated symbols, etc.), a mapping of the UL reference signal code to frequency resources, a repetition rate and/or periodicity of the UL reference signal, and/or a frequency pattern (or comb) of the UL reference signal. The UL reference signal may be a sounding reference signal (SRS), possibly a SRS dedicated to a specific usage, for instance an SRS useable for out-of-band emission or ACLR characterization.

At operation S6.2, the network device 620 requests a UL reference signal from the user device 610. The request can include the configuration information, such that the user device 610 can configure the UL reference signal according to the configuration information (e.g., as described in relation to FIG. 3B, and FIG. 4). In some implementations, the user device 610 can determine at least some of the configuration information (e.g., based on measurements at the user device 610, values defined in a standard, etc.). The request can also include (or be interpreted to include) a request that the UL reference signal be sent without use of DPD at the user device 610 (e.g., such that the network device 620 can detect whether the user device 610 can comply with ACLR requirements without use of DPD).

At operation S6.3, the user device 610 transmits the UL reference signal to the network device 620. For instance, the user device 610 can configure and generate the UL reference signal according to the (received and/or determined) configuration information. The user device 610 can upconvert the generated signal, and amplify the upconverted signal to a given UL transmission power (e.g., which can be based on decisions at the UE and/or UL transmit power control information in the configuration information). Furthermore, the user device 610 can de-activate DPD prior to transmission of the UL reference signal. The network device 620 can receive the UL reference signal transmitted by the user device 610.

At operation S6.4, the network device 620 can measure (or in other words, characterize, determine, calculate, etc.,) the ACLR of the user device 610 based on the received UL reference signal. For instance, the network device 620 can construct the transmission spectrum of the user device 610 based on the received UL reference signal from the user device 610.

In other words, the network device 620 can measure the received power over the entire reception bandwidth (or a portion of it large enough to characterize the ACLR, e.g., the frequency portion allocated for the UL reference signal, and adjacent channels to the frequency portion having the same BW as the frequency portion, as described in relation to FIG. 4). The network device 620 can also measure the received power within frequency portion (otherwise called the effective transmission BW). The network device 620 can then assess how much power leakage occurs outside the frequency portion. In particular, the ratio between the received power inside the frequency portion and the received power over the entire reception bandwidth (or, as mentioned, over the frequency portion and adjacent channels to the frequency portion having the same BW as the frequency portion), can be used to determine the ACLR.

At operation S6.5, the network device 620 transmits, to the user device 610, an indication of whether or not to activate DPD for subsequent UL transmission by the user device 610. The user device 610 can then receive the indication. In some implementations, the indication can be carried in a new IE, or MAC CE, or via RRC.

In some implementations, the network device 620 can determine whether the ACLR of the user device 610 exceeds a threshold ACLR. When the threshold ACLR is exceeded, this can indicate that DPD should be used at the user device 610 to avoid ACLR violations during subsequent UL transmissions (e.g., which may not be configured with a relatively small BW). As such, the indication transmitted to the user device 610 can include a request for DPD to be activated at the user device 610 for subsequent UL transmissions. For instance, the indication can include a value (e.g., a flag) indicative of a request to activate DPD. Similarly, if the threshold ACLR is not exceeded, this can indicate that DPD is not necessary for use at the user device 610. As such, the indication transmitted to the user device 610 can include a value indicative of a request not to activate DPD for subsequent UL transmissions by the user device 610 (or, in other words, to continue not using DPD for UL transmissions, since DPD was deactivated for transmission of the UL reference signal).

Additionally or alternatively, the indication can include the characterization of the ACLR and/or some value derived from the characterization, such as an ACLR headroom between the measured ACLR and the threshold ACLR. The user device 610 itself can then make a decision, based on the indication, whether or not to activate DPD for subsequent UL transmissions. For instance, if the user device 610 determines, based on the indication, that the ACLR exceeds a threshold ACLR, the user device 610 can determine to activate DPD for performance of subsequent UL transmission. Similarly, if the user device 610 determines, based on the indication, that the ACLR does not exceed the threshold ACLR, the user device 610 can determined not to activate DPD for performance of subsequent UL transmissions (or, in other words, to continue not using DPD for UL transmissions).

At operation S6.6, the user device 610 takes action based on the indication received from the network device 620.

When the indication indicates that DPD should be activated (e.g., because it includes a request to activate DPD and/or because it includes information derived from the ACLR which can be used by the user device 610 to determine whether or not to activate DPD), the user device 610 can activate DPD for performance of subsequent UL transmission. In other words, the user device 610 enables the transmission block that performs DPD on the signal to be transmitted (i.e., the DPD block, or sub-system).

More specifically, the DPD block can receive, as input, the signal to be transmitted, and apply a predistortion to produce an output signal which is then amplified by a PA (e.g., as described in relation to FIG. 1). In some implementations, the extent of the predistortion applied in performing DPD can be configured, for instance, based on a target ACLR and/or the headroom, etc.

Similarly, when the indication does not indicate that DPD should be activated, the user device 610 can continue to perform subsequent UL transmission without DPD.

At operation S6.7, the user device 610 reports its updated DPD status to the network device 620. For instance, when DPD has been activated for performance of subsequent UL transmissions by the user device 610, the user device 610 can transmit information indicative of DPD being active to the network device 620. Similarly, when DPD has not been activated, the user device 610 can transmit information indicative of DPD not being active to the network device 620. In some implementations, the user device 610 can report its DPD status responsive to a request, from the network device 620, to do so. Additionally or alternatively, the user device 610 can report its DPD status responsive to any action taken at operation S6.6 (e.g., based on activating or de-activating DPD based on the received indication).

At operation S6.8, the user device 610 and/or the network device 620 decides to change the UL transmit power by the user device 620. This can occur, for instance, when the distance between the user device 610 and the network device 620 changes (e.g., since the greater the distance, the higher UL transmit power is required for successful transmission). For instance, when operating with closed loop power control, the network device 620 can determine whether the received power of UL transmissions from the user device 610 should be increased or decreased. The network device 620 can feedback this information to the user device 610 accordingly (e.g., as a UL transmit power control command to increase or decrease the UL transmit power). The user device 610 can then adjust the UL transmit power, based on the received feedback. Additionally or alternatively, when operating with an open loop power control, the user device 610 can estimate, based on a received power of a reference signal transmitted with a known transmit power by the network device 620, a target UL transmit power (e.g., since it can be assumed that the UL losses and downlink (DL) losses will be correlated). If the target UL transmit power is different to the current UL transmit power, the user device 610 can determine to change to the target UL transmit power.

Responsive to deciding to change the UL transmit power, the spectrum detection procedure can be re-triggered, so that it can be determined whether or not to activate DPD for performance of subsequent UL transmission at the updated UL transmit power (e.g., based on another UL reference signal transmitted at the updated UL transmit power). For instance, if the network device 620 determines to change the UL transmit power, the network device 620 can trigger itself to return to operation S6.1, as described herein. Additionally or alternatively, if the user device 610 decides to change the UL transmit power (or if a power control command is received at the user device 610), the user device 610 can request the network device 620 to trigger the spectrum detection procedure again at operation S6.1.

In some implementations, when DPD is already activated at the user device 610, the spectrum detection procedure can be re-triggered only when the UL transmit power is to be decreased. This is because, given that it can be assumed that ACLR will increase with an increase in amplification by the PA, if DPD is already required at the user device 610 at a lower amplification it can be assumed that it will be required at the higher amplification, so there is no need to perform the operations to check this. Similarly, in some additional or alternative implementations, when DPD is not active at the user device 610, the spectrum detection procedure can be re-triggered only when the UL transmit power is to be increased. This is because, given that it can be assumed that ACLR will decrease with a decrease in amplification by the PA, if DPD is not required at a higher amplification, it can be assumed that it will not be required at the lower amplification as well, so there is no need to perform the operations to check this. In this way, computational and network resources that would otherwise be consumed in determining whether or not DPD is required in the above circumstances can be saved.

In some implementations, the operations described in relation to FIG. 6 can be extended for use with UL CA. For instance, as described herein, the user device 610 can be configured to transmit multiple UL reference signals in multiple CCs (e.g., each with a small BWP). For each of the UL reference signals, the network device 620 can assess whether the ACLR of the user device 610 obeys a ACLR threshold in order to assess whether the user device 610 should activate DPD for performance of subsequent UL transmission on each of the CCs respectively. The configuration information sent to the user device 610 and/or determined at the user device 610 can be extended accordingly.

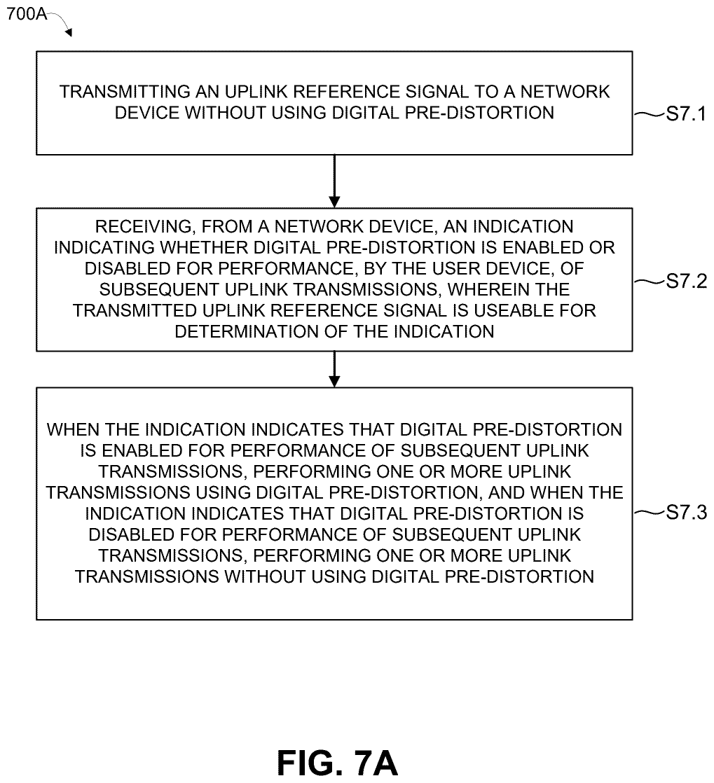

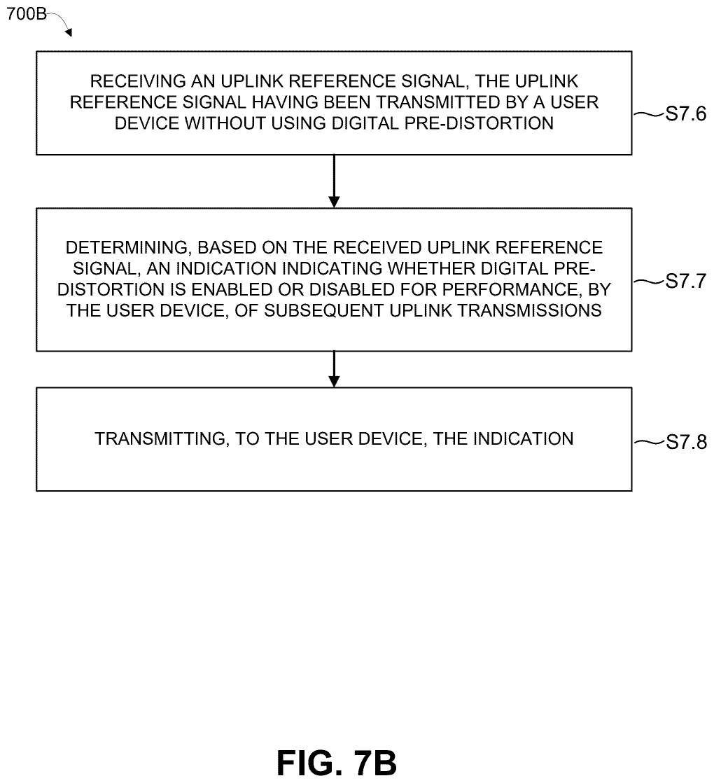

Turning to FIG. 7A, a flowchart depicting a method 700A performed in accordance with an example embodiment is depicted. The method 700A may be performed by a user device, such as a user device as described in relation to any of the FIGs described herein.

At operation S7.1, the method 700A includes transmitting an uplink reference signal to a network device without using digital pre-distortion.

In some implementations, the uplink reference signal is configured to be transmitted over a frequency portion of a reception bandwidth of the network device. The location and width of the frequency portion can be tailored so as to allow the network device to characterize an Adjacent Channel Leakage power Ratio, ACLR, of the user device within the reception bandwidth (for instance, as described in relation to FIGS. 3B and 4). For instance, a difference between a lower edge of the frequency portion and a lower edge of the reception bandwidth can be greater than or equal to a width of the frequency portion. Furthermore, a difference between an upper edge of the reception bandwidth and an upper edge of the frequency portion can be greater than or equal to the width of the frequency portion.

In some implementations, configuration information for configuring an uplink bandwidth part can be received from the network device. The transmission of the uplink reference signal can thus be confined within the configured uplink bandwidth part. For instance, the uplink bandwidth part can be configured so as to span a minimum allowed number of physical resource blocks. Furthermore, the uplink bandwidth part can be configured so as to be located at a central position (e.g., at the centre, within a threshold bandwidth of the centre, etc.) of the reception bandwidth.

In some implementations, the uplink reference signal can be transmitted, to the network device, responsive to a request received from the network device. For instance, the request can be received responsive to a change in uplink transmit power by the user device (e.g., determined by the user device or by the network device).

At operation S7.2, the method 700A includes receiving, from a network device, an indication indicating whether digital pre-distortion is enabled or disabled for performance, by the user device, of subsequent uplink transmissions, wherein the transmitted uplink reference signal is useable for determination of the indication.

In some implementations, when the indication indicates that digital pre-distortion is disabled for performance of subsequent uplink transmissions, digital pre-distortion is disabled for performance of subsequent uplink transmissions as long as the subsequent uplink transmissions are performed with a transmit power value that is lower than a reference transmit power value with which the uplink reference signal is transmitted. Additionally or alternatively, when the indication indicates that digital pre-distortion is enabled for performance of subsequent uplink transmissions, digital pre-distortion is enabled for performance of subsequent uplink transmissions as long as the subsequent uplink transmissions are performed with a transmit power value that is greater than or equal to a reference transmit power value with which the uplink reference signal is transmitted.

At operation S7.3, the method 700A includes, when the indication indicates that digital pre-distortion is enabled for performance of subsequent uplink transmissions, performing one or more uplink transmissions using digital pre-distortion, and when the indication indicates that digital pre-distortion is disabled for performance of subsequent uplink transmissions, performing one or more uplink transmissions without using digital pre-distortion.

In some implementations, information indicative of whether digital pre-distortion is currently enabled or disabled for performance of uplink transmissions by the user device is transmitted to the network device.

In some implementations, a request to re-determine the indication indicating whether digital pre-distortion is enabled or disabled for performance, by the user device, of subsequent uplink transmissions is transmitted to the network device. For instance, this may be in response to the user device determining that the uplink transmit power should be changed.

Turning to FIG. 7B, a flowchart depicting a method 700B performed in accordance with an example embodiment is depicted. The method 700B may be performed by a network device, such as a network device as described in relation to any of the FIGs described herein.

At operation S7.6, the method 700B includes receiving an uplink reference signal, the uplink reference signal having been transmitted by a user device without using digital pre-distortion.

In some implementations, the method 700B further includes configuring the uplink reference signal to be transmitted over a frequency portion of a reception bandwidth of the network device. The location and width of the frequency portion can be tailored so as to allow the network device to characterize an Adjacent Channel Leakage power Ratio, ACLR, of the user device within the reception bandwidth. An ACLR of the user device within the reception bandwidth can then be characterized, based on the received uplink reference signal. For instance, a difference between a lower edge of the frequency portion and a lower edge of the reception bandwidth can be greater than or equal to a width of the frequency portion. Furthermore, a difference between an upper edge of the reception bandwidth and an upper edge of the frequency portion can be greater than or equal to the width of the frequency portion.

For instance, in some implementations, the method 700B further includes determining configuration information for configuring an uplink bandwidth part in which the transmission of the uplink reference signal is confined. The configuration information can then be transmitted to the user device. For instance, the configuration information can be determined so that the uplink bandwidth part (i) spans a minimum allowed number of physical resource blocks, and (ii) is located at a central position of the reception bandwidth.

In some implementations, the uplink reference signal can be received responsive to a request transmitted to the user device. For instance, the request can be indicative of the configuration of the uplink reference signal. In some implementations, the request can be transmitted responsive to a change in uplink transmit power by the user device (e.g., as determined by the network device or the user device).

At operation S7.7, the method 700B includes determining, based on the received uplink reference signal, an indication indicating whether digital pre-distortion is enabled or disabled for performance, by the user device, of subsequent uplink transmissions. For instance, determining the indication can include characterizing, based on the received uplink reference signal, an ACLR of the user device. In some implementations, the indication can include information about the characterization of the ACLR. The user device can then itself determine, based on the characterization, whether or not to activate DPD for subsequent uplink transmissions (e.g., when the user device determines the ACLR exceeds a threshold ACLR). Additionally or alternatively, the network device can determine, based on the characterization of the ACLR, whether or not to activate DPD for subsequent uplink transmissions (e.g., when the network determines that the ACLR exceeds a threshold ACLR), and the indication can therefore include a request to activate or not activate DPD for subsequent uplink transmissions.

At operation S7.8, the method 700B includes transmitting, to the user device, the indication.

In some implementations, when the indication indicates that digital pre-distortion is disabled for performance of subsequent uplink transmissions, the indication can indicate that digital pre-distortion is disabled for performance of subsequent uplink transmissions as long as the subsequent uplink transmissions are performed with a transmit power value that is lower than a reference transmit power value with which the uplink reference signal is transmitted. Additionally or alternatively, when the indication indicates that digital pre-distortion is enabled for performance of subsequent uplink transmissions, the indication can indicate that digital pre-distortion is enabled for performance of subsequent uplink transmissions as long as the subsequent uplink transmissions are performed with a transmit power value that is greater than or equal to a reference transmit power value with which the uplink reference signal is transmitted.

In some implementations, information indicative of whether digital pre-distortion is currently enabled or disabled for performance of uplink transmissions can be received by the user device (e.g., responsive to a request for the DPD status). Additionally or alternatively, a request to re-determine the indication indicating whether digital pre-distortion is enabled or disabled for performance, by the user device, of subsequent uplink transmissions can be received from the user device (e.g., responsive to a determination at the user device that the uplink transmit power should be changed).

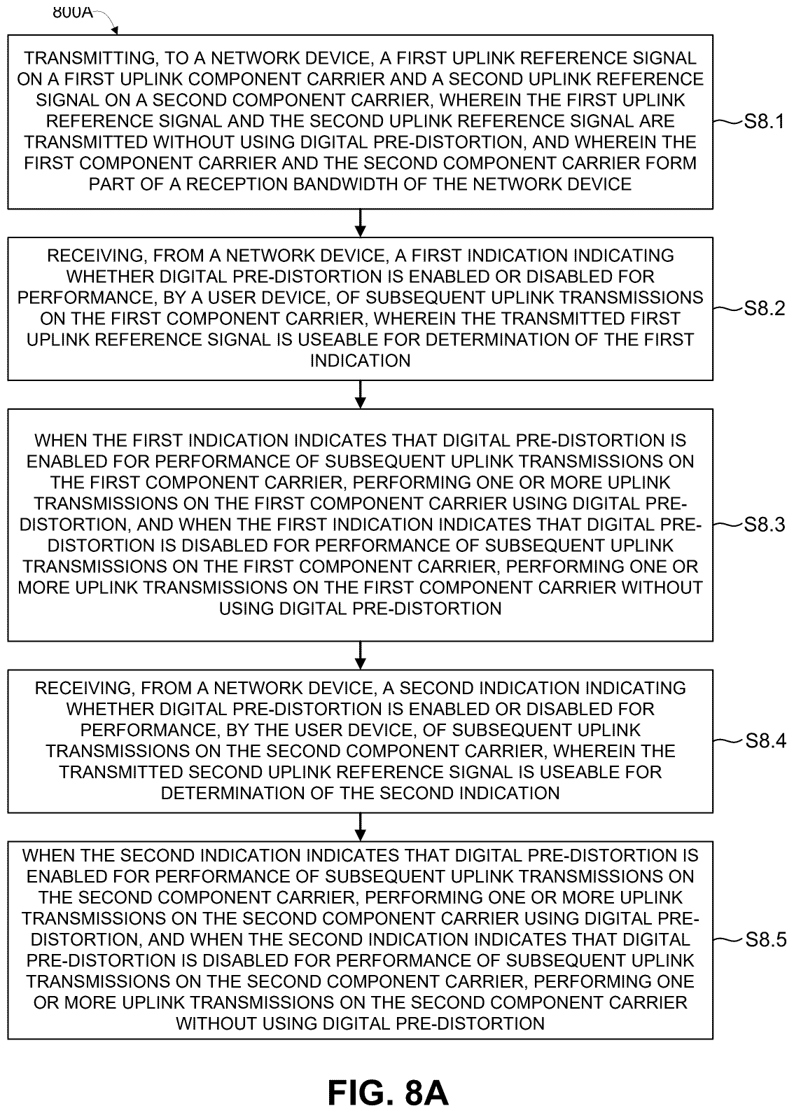

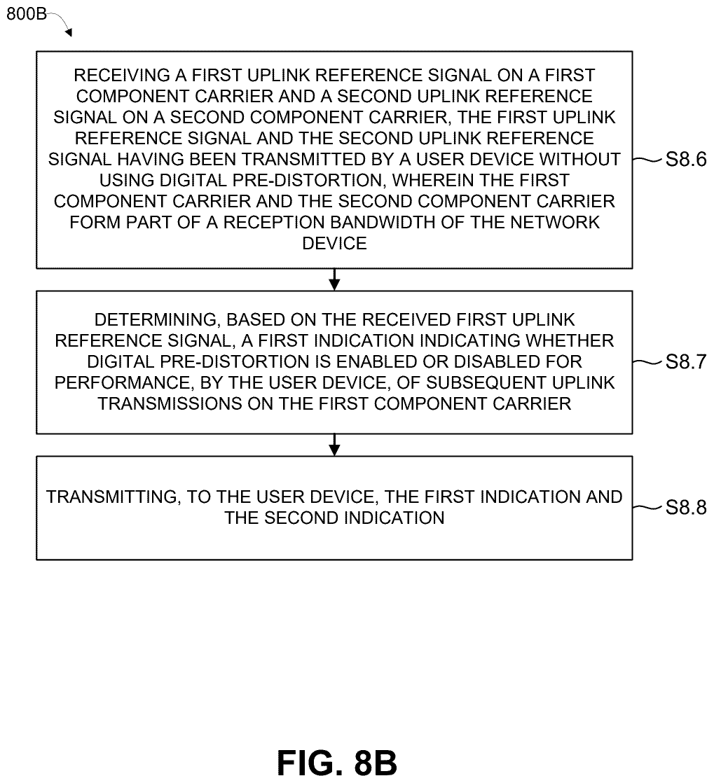

Turning to FIG. 8A, a flowchart depicting a method 800A performed in accordance with an example embodiment is depicted. The method 800A may be performed by a user device, such as a user device as described in relation to any of the FIGs described herein. Although the method 800A is generally described in relation to a first uplink reference signal on a first component carrier and a second uplink reference signal on a second component carrier, it will be appreciated that in some implementations, more uplink reference signals on corresponding component carriers can be used. In fact, the method 800A can be used with any number (>1) of uplink reference signals on corresponding component carriers.

At operation S8.1, the method 800A includes transmitting, to a network device, a first uplink reference signal on a first component carrier and a second uplink reference signal on a second component carrier, wherein the first uplink reference signal and the second uplink reference signal are transmitted without using digital pre-distortion, and wherein the first component carrier and the second component carrier form part of a reception bandwidth of the network device. For instance, the first uplink reference signal and the second uplink reference signal can be transmitted in response to receiving a request from the network device (e.g., during an initial connection procedure, or when it is determined that the uplink transmit power on both the first component carrier and the second component carrier is changed).

The first uplink reference signal can be configured to be transmitted over a first frequency portion of the first component carrier. The location and width of the first frequency portion can be tailored so as to allow the network device to characterize a first Adjacent Channel Leakage power Ratio, ACLR, of the user device within the reception bandwidth. For instance, the first uplink reference signal can be configured such that a difference between a lower edge of the first frequency portion and a lower edge of the reception bandwidth of the network device is greater than or equal to a width of the first frequency portion. Furthermore, the first uplink reference signal can be configured such that a difference between an upper edge of the reception bandwidth and an upper edge of the first frequency portion is greater than or equal to the width of the first frequency portion.

Similarly, the second uplink reference signal can be configured to be transmitted over a second frequency portion of the second component carrier. The location and width of the second frequency portion can be tailored so as to allow the network device to characterize a second ACLR of the user device within the reception bandwidth. For instance, the second uplink reference signal can be configured such that a difference between a lower edge of the second frequency portion and the lower edge of the reception bandwidth is greater than or equal to a width of the second frequency portion. Furthermore, the second uplink reference signal can be configured such that a difference between the upper edge of the reception bandwidth and an upper edge of the second frequency portion is greater than or equal to the width of the second frequency portion.

In some implementations, the uplink reference signals can be configured to be confined within their respective component carrier bandwidths. For instance, the first uplink reference signal can be configured such that a difference between a lower edge of the first frequency portion and a lower edge of a first component carrier bandwidth is greater than or equal to a width of the first frequency portion, and a difference between an upper edge of the first component carrier bandwidth and an upper edge of the first frequency portion is greater than or equal to the width of the first frequency portion. Similarly, the second uplink reference signal can be configured such that a difference between a lower edge of the second frequency portion and a lower edge of a second component carrier bandwidth is greater than or equal to a width of the second frequency portion, and a difference between an upper edge of the second component carrier bandwidth and an upper edge of the second frequency portion is greater than or equal to the width of the second frequency portion.

In some implementations, the uplink reference signals can be separated from one another such that interference between the uplink reference signals is minimized. For instance, the uplink reference signals can be configured such that a difference between an upper edge of the first frequency portion and a lower edge of the second frequency portion is greater than or equal to a width of the first frequency portion and the second frequency portion, or a difference between an upper edge of the second frequency portion and a lower edge of the first frequency portion is greater than or equal to a width of the first frequency portion and the second frequency portion.

In some implementations, configuration information for configuring a first uplink bandwidth part and a second uplink bandwidth part can be received from the network device. The transmission of the first uplink reference signal can then be confined within the configured first uplink bandwidth part, and the transmission of the second uplink reference signal can be confined within the configured second uplink bandwidth part. For instance, the first and second uplink bandwidth parts can be configured so as to span a minimum allowed number of physical resource blocks. Furthermore, the first uplink bandwidth part can be configured so as to be located at a central position of the first component carrier bandwidth. Similarly, the second uplink bandwidth part can be configured so as to be located at a central position of the second component carrier bandwidth.

At operation S8.2, the method 800A includes receiving, from a network device, a first indication indicating whether digital pre-distortion is enabled or disabled for performance, by a user device, of subsequent uplink transmissions on the first component carrier, wherein the transmitted first uplink reference signal is useable for determination of the first indication.

For instance, the first uplink reference signal can be usable for characterization at the network device of a first ACLR of the user device within the reception bandwidth. As such, ACLR information derived from the characterization of the first ACLR based on the first uplink reference signal can be received from the network device (e.g., as at least part of the indication).

At operation S8.3, the method 800A includes, when the first indication indicates that digital pre-distortion is enabled for performance of subsequent uplink transmissions on the first component carrier, performing one or more uplink transmissions on the first component carrier using digital pre-distortion, and when the first indication indicates that digital pre-distortion is disabled for performance of subsequent uplink transmissions on the first component carrier, performing one or more uplink transmissions on the first component carrier without using digital pre-distortion.

In some implementations, when the first indication that digital pre-distortion is disabled for performance of subsequent uplink transmissions, digital pre-distortion can be disabled for performance of subsequent uplink transmissions on the first component carrier as long as the subsequent uplink transmissions are performed with a transmit power value that is lower than a corresponding reference transmit power value with which the first uplink reference signal is transmitted. Furthermore, when the first indication indicates that digital pre-distortion is enabled for performance of subsequent uplink transmissions, digital pre-distortion can be enabled for performance of subsequent uplink transmissions on the first component carrier as long as the subsequent uplink transmissions are performed with a transmit power value that is greater than or equal to a corresponding reference transmit power value with which the first uplink reference signal is transmitted.

At operation S8.4, the method 800A includes receiving, from a network device, a second indication indicating whether digital pre-distortion is enabled or disabled for performance, by the user device, of subsequent uplink transmissions on the second component carrier, wherein the transmitted second uplink reference signal is useable for determination of the second indication.

For instance, the second uplink reference signal can be usable for characterization at the network device of a second ACLR of the user device within the reception bandwidth. As such, ACLR information derived from the characterization of the second ACLR based on the second uplink reference signal can be received from the network device (e.g., as at least part of the indication).

At operation S8.5, the method 800A includes, when the second indication indicates that digital pre-distortion is enabled for performance of subsequent uplink transmissions on the second component carrier, performing one or more uplink transmissions on the second component carrier using digital pre-distortion, and when the second indication indicates that digital pre-distortion is disabled for performance of subsequent uplink transmissions on the second component carrier, performing one or more uplink transmissions on the second component carrier without using digital pre-distortion.

In some implementations, when the second indication that digital pre-distortion is disabled for performance of subsequent uplink transmissions, digital pre-distortion can be disabled for performance of subsequent uplink transmissions on the second component carrier as long as the subsequent uplink transmissions are performed with a transmit power value that is lower than a corresponding reference transmit power value with which the second uplink reference signal is transmitted. Furthermore, when the second indication indicates that digital pre-distortion is enabled for performance of subsequent uplink transmissions, digital pre-distortion can be enabled for performance of subsequent uplink transmissions on the second component carrier as long as the subsequent uplink transmissions are performed with a transmit power value that is greater than or equal to a corresponding reference transmit power value with which the second uplink reference signal is transmitted.

In some implementations, if it is determined that the uplink transmit power on one of the component carriers changes, use of DPD on that component carrier can be reevaluated independently. For instance, in response to a change in uplink transmit power by the user device on the first component carrier, a request for transmitting the first uplink reference signal can be received from the network device. The first uplink reference signal can then be transmitted in response to the request. In this case, the second uplink reference signal may not be transmitted (e.g., because the request did not relate to the second uplink reference signal and/or was not responsive to a change in uplink transmit power by the user device on the second component carrier).

In some implementations, the method 800A can further include transmitting, to the network device, information indicative of whether digital pre-distortion is currently enabled or disabled for performance of uplink transmissions on the first component carrier and/or the second component carrier by the user device. In some implementations, the method 800A can further include transmitting, to the network device, a request to re-determine the first indication and/or the second indication (e.g., when a change in the uplink transmit power on the first component carrier and/or the second component carrier is determined at the user device).

Turning to FIG. 8B, a flowchart depicting a method 800B performed in accordance with an example embodiment is depicted. The method 800B may be performed by a network device, such as a network device as described in relation to any of the FIGs described herein. Although the method 800A is generally described in relation to a first uplink reference signal on a first component carrier and a second uplink reference signal on a second component carrier, it will be appreciated that in some implementations, more uplink reference signals on corresponding component carriers can be used. In fact, the method 800A can be used with any number (>1) of uplink reference signals on corresponding component carriers.

At operation S8.6, the method 800B includes receiving a first uplink reference signal on a first component carrier and a second uplink reference signal on a second component carrier, the first uplink reference signal and the second uplink reference signal having been transmitted by a user device without using digital pre-distortion, wherein the first component carrier and the second component carrier form part of a reception bandwidth of the network device. For instance, the first uplink reference signal and the second uplink reference signal can be received in response to transmitting a request from the user device (e.g., during an initial connection procedure, or when it is determined that the uplink transmit power on both the first component carrier and the second component carrier is changed).

In some implementations, the method 800B can include configuring the first uplink reference signal to be transmitted over a first frequency portion of the first component carrier, and configuring the second uplink reference signal to be transmitted over a second frequency portion of the second component carrier. The location and width of the frequency portion can be tailored so as to allow the network device to characterize a first Adjacent Channel Leakage power Ratio, ACLR, of the user device within the reception bandwidth. For instance, the first uplink reference signal can be configured such that a difference between a lower edge of the first frequency portion and a lower edge of the reception bandwidth of the network device is greater than or equal to a width of the first frequency portion, and a difference between an upper edge of the reception bandwidth and an upper edge of the first frequency portion is greater than or equal to the width of the first frequency portion. Similarly, the location and width of the second frequency portion can be tailored so as to allow the network device to characterize a second Adjacent Channel Leakage power Ratio, ACLR, of the user device within the reception bandwidth. For instance, the second uplink reference signal can be configured such that a difference between a lower edge of the second frequency portion and the lower edge of the reception bandwidth is greater than or equal to a width of the second frequency portion, and a difference between the upper edge of the reception bandwidth and an upper edge of the second frequency portion is greater than or equal to the width of the second frequency portion.

In some implementations, the uplink reference signals can be configured to be confined within their respective component carrier bandwidths. For instance, the first uplink reference signal can be configured such that a difference between a lower edge of the first frequency portion and a lower edge of a first component carrier bandwidth is greater than or equal to a width of the first frequency portion, and a difference between an upper edge of the first component carrier bandwidth and an upper edge of the first frequency portion is greater than or equal to the width of the first frequency portion. Similarly, the second uplink reference signal can be configured such that a difference between a lower edge of the second frequency portion and a lower edge of a second component carrier bandwidth is greater than or equal to a width of the second frequency portion, and a difference between an upper edge of the second component carrier bandwidth and an upper edge of the second frequency portion is greater than or equal to the width of the second frequency portion.

In some implementations, the uplink reference signals can be separated from one another such that interference between the uplink reference signals is minimized. For instance, the uplink reference signals can be configured such that a difference between an upper edge of the first frequency portion and a lower edge of the second frequency portion is greater than or equal to a width of the first frequency portion and the second frequency portion, or a difference between an upper edge of the second frequency portion and a lower edge of the first frequency portion is greater than or equal to a width of the first frequency portion and the second frequency portion.

In some implementations, the method 800B can include determining configuration information for configuring a first uplink bandwidth part and a second uplink bandwidth part, and transmitting, to the user device, the configuration information. The transmission of the first uplink reference signal can then be confined within the configured first uplink bandwidth part, and the transmission of the second uplink reference signal can be confined within the configured second uplink bandwidth part. For instance, the first and second uplink bandwidth parts can be configured so as to span a minimum allowed number of physical resource blocks. Furthermore, the first uplink bandwidth part can be configured so as to be located at a central position of the first component carrier bandwidth. Similarly, the second uplink bandwidth part can be configured so as to be located at a central position of the second component carrier bandwidth.

At operation S8.7, the method 800B includes determining, based on the received first uplink reference signal, a first indication indicating whether digital pre-distortion is enabled or disabled for performance, by the user device, of subsequent uplink transmissions on the first component carrier.

In some implementations, the method 800B can include characterizing, based on the first uplink reference signal and the second uplink reference signal, a first ACLR of the user device within the reception bandwidth and a second ACLR of the user device within the reception bandwidth. ACLR information derived from the first ACLR and/or the second ACLR can then be transmitted to the user device (e.g., as at least part of the indication).

At operation S8.8, the method 800B includes transmitting, to the user device, the first indication and the second indication.

In some implementations, when the first indication and/or the second indication indicates that digital pre-distortion is disabled for performance of subsequent uplink transmissions, the first indication and/or the second indication can indicate that digital pre-distortion is disabled for performance of subsequent uplink transmissions on the first component carrier and/or the second component carrier respectively as long as the subsequent uplink transmissions are performed with a transmit power value that is lower than a corresponding reference transmit power value with which the respective one of the first uplink reference signal and the second uplink reference signal is transmitted. Furthermore, when the first indication and/or the second indication indicates that digital pre-distortion is enabled for performance of subsequent uplink transmissions, the first indication and/or the second indication can indicate that digital pre-distortion is enabled for performance of subsequent uplink transmissions on the first component carrier and/or the second component carrier respectively as long as the subsequent uplink transmissions are performed with a transmit power value that is greater than or equal to a corresponding reference transmit power value with which the respective one of the first uplink reference signal and the second uplink reference signal is transmitted.

In some implementations, if it is determined that the uplink transmit power on one of the component carriers changes, use of DPD on that component carrier can be reevaluated independently. For instance, in response to a change in uplink transmit power by the user device on the first component carrier, a request for transmitting the first uplink reference signal can be transmitted to the user device. The first uplink reference signal can then be received in response to the request. In this case, the second uplink reference signal may not be received (e.g., because the request did not relate to the second uplink reference signal and/or was not responsive to a change in uplink transmit power by the user device on the second component carrier).

In some implementations, the method 800B can include receiving, from the user device, information indicative of whether digital pre-distortion is currently enabled or disabled for performance of uplink transmissions on the first component carrier and/or the second component carrier by the user device. Additionally or alternatively, the method 800B can include receiving, from the user device, a request to re-determine the first indication and/or the second indication.

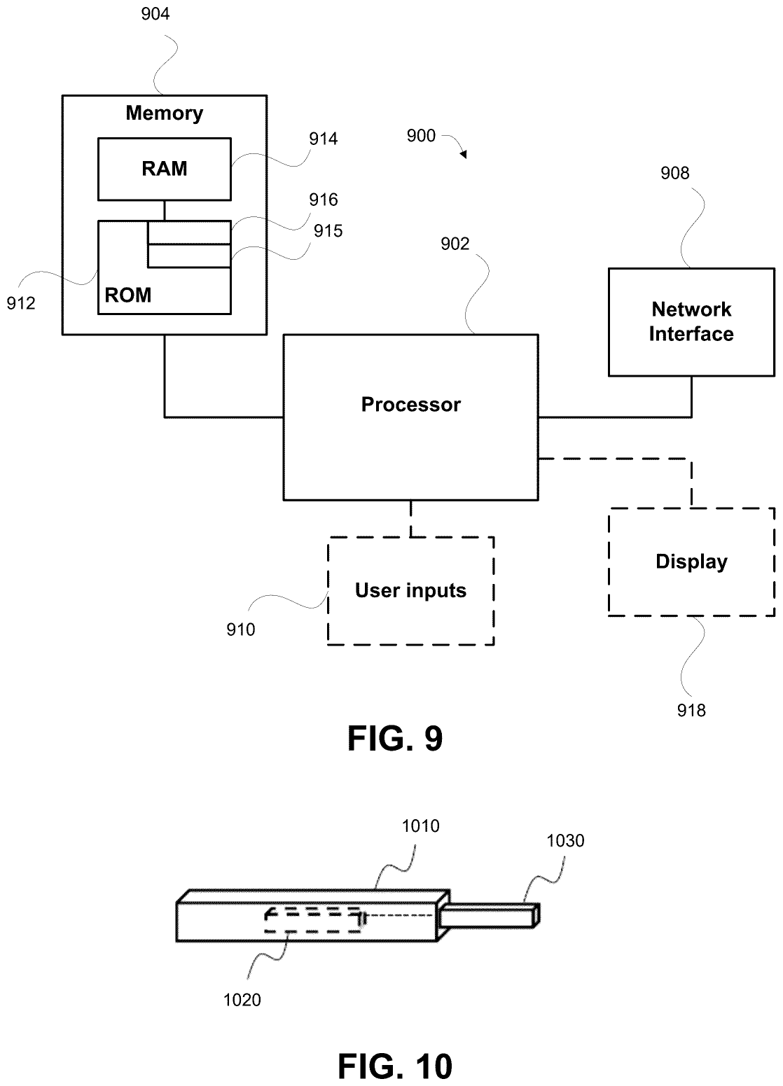

Turning to FIG. 9, components of one or more of the example embodiments described previously is depicted, which hereafter are referred to generically as a processing system 900. The processing system 900 may, for example, be the apparatus referred to in the claims below.

The processing system 900 may have a processor 902, a memory 904 closely coupled to the processor 902 and comprised of a RAM 914 and a ROM 912, and, optionally, a user input 910 and a display 918. The processing system 900 may comprise one or more network/apparatus interfaces 908 for connection to a network/apparatus, e.g., a modem which may be wired or wireless. The network/apparatus interface 908 may also operate as a connection to other apparatus such as device/apparatus which is not network side apparatus. Thus, direct connection between devices/apparatus without network participation is possible.

The processor 902 is connected to each of the other components in order to control operation thereof.

The memory 904 may comprise a non-volatile memory, such as a hard disk drive (HDD) or a solid-state drive (SSD). The ROM 912 of the memory 904 stores, amongst other things, an operating system 915 and may store software applications 916. The RAM 914 of the memory 904 is used by the processor 902 for the temporary storage of data. The operating system 915 may contain code which, when executed by the processor implements aspects of the algorithms and sequences described above. Note that in the case of small device/apparatus the memory can be most suitable for small size usage i.e., not always a hard disk drive (HDD) or a solid-state drive (SSD) is used.

The processor 902 may take any suitable form. For instance, it may be a microcontroller, a plurality of microcontrollers, a processor, or a plurality of processors.

The processing system 900 may be a standalone computer, a server, a console, or a network thereof. The processing system 900 and needed structural parts may be all inside device/apparatus such as IoT device/apparatus i.e., embedded to very small size.

In some example embodiments, the processing system 900 may also be associated with external software applications. These may be applications stored on a remote server device/apparatus and may run partly or exclusively on the remote server device/apparatus. These applications may be termed cloud-hosted applications. The processing system 900 may be in communication with the remote server device/apparatus in order to utilize the software application stored there.

FIG. 10 shows a tangible media, in the form of a removable memory unit 1010, storing computer-readable code which when run by a computer may perform methods according to example embodiments described above. The removable memory unit 1010 may be a memory stick, e.g., a USB memory stick, having internal memory 1020 storing the computer-readable code. The internal memory 1020 may be accessed by a computer system via a connector 1030. Of course, other forms of tangible storage media may be used, as will be readily apparent to those of ordinary skilled in the art. Tangible media can be any device/apparatus capable of storing data/information which data/information can be exchanged between devices/apparatus/network.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any non-transitory media or means that can contain, store, communicate, propagate or transport the instructions for use by or in connection with an instruction execution system, apparatus, or device, such as a computer.

Reference to, where relevant, “computer-readable medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialised circuits such as field programmable gate arrays FPGA, application specify circuits ASIC, signal processing devices/apparatus and other devices/apparatus. References to computer program, instructions, code etc. should be understood to express software for a programmable processor firmware such as the programmable content of a hardware device/apparatus as instructions for a processor or configured or configuration settings for a fixed function device/apparatus, gate array, programmable logic device/apparatus, etc.

If desired, the different functions discussed herein may be performed in a different order and/or concurrently with each other. Furthermore, if desired, one or more of the above-described functions may be optional or may be combined. Similarly, it will also be appreciated that the flow diagrams and sequences described herein are examples only and that various operations depicted therein may be omitted, reordered and/or combined.

It will be appreciated that the above-described example embodiments are purely illustrative and are not limiting on the scope of the invention. Other variations and modifications will be apparent to persons skilled in the art upon reading the present specification.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

Although various aspects of the invention are set out in the independent claims, other aspects of the invention comprise other combinations of features from the described example embodiments and/or the dependent claims with the features of the independent claims, and not solely the combinations explicitly set out in the claims.

It is also noted herein that while the above describes various examples, these descriptions should not be viewed in a limiting sense. Rather, there are several variations and modifications which may be made without departing from the scope of the present invention as defined in the appended claims.

1.-26. (canceled)

27. A user device comprising:
means for transmitting, to a network device, a first uplink reference signal on a first component carrier and a second uplink reference signal on a second component carrier, wherein the first uplink reference signal and the second uplink reference signal are transmitted without using digital pre-distortion, and wherein the first component carrier and the second component carrier form part of a reception bandwidth of the network device;
means for receiving, from a network device, a first indication indicating whether digital pre-distortion is enabled or disabled for performance, by the user device, of subsequent uplink transmissions on the first component carrier, wherein the transmitted first uplink reference signal is useable for determination of the first indication;
means for, when the first indication indicates that digital pre-distortion is enabled for performance of subsequent uplink transmissions on the first component carrier, performing one or more uplink transmissions on the first component carrier using digital pre-distortion, and when the first indication indicates that digital pre-distortion is disabled for performance of subsequent uplink transmissions on the first component carrier, performing one or more uplink transmissions on the first component carrier without using digital pre-distortion;
means for receiving, from a network device, a second indication indicating whether digital pre-distortion is enabled or disabled for performance, by the user device, of subsequent uplink transmissions on the second component carrier, wherein the transmitted second uplink reference signal is useable for determination of the second indication; and
means for, when the second indication indicates that digital pre-distortion is enabled for performance of subsequent uplink transmissions on the second component carrier, performing one or more uplink transmissions on the second component carrier using digital pre-distortion, and when the second indication indicates that digital pre-distortion is disabled for performance of subsequent uplink transmissions on the second component carrier, performing one or more uplink transmissions on the second component carrier without using digital pre-distortion.

28. The user device of claim 27, wherein the first uplink reference signal is configured to be transmitted over a first frequency portion of the first component carrier, and wherein a location and a width of the first frequency portion are tailored so as to allow the network device to characterize a first Adjacent Channel Leakage power Ratio, ACLR, of the user device within the reception bandwidth, and
wherein the second uplink reference signal is configured to be transmitted over a second frequency portion of the second component carrier, and wherein a location and a width of the second frequency portion are tailored so as to allow the network device to characterize a second ACLR of the user device within the reception bandwidth.

29. The user device of claim 28, wherein a difference between a lower edge of the first frequency portion and a lower edge of the reception bandwidth is greater than or equal to a width of the first frequency portion, and wherein a difference between an upper edge of the reception bandwidth and an upper edge of the first frequency portion is greater than or equal to the width of the first frequency portion, and
wherein a difference between a lower edge of the second frequency portion and the lower edge of the reception bandwidth is greater than or equal to a width of the second frequency portion, and wherein a difference between the upper edge of the reception bandwidth and an upper edge of the second frequency portion is greater than or equal to the width of the second frequency portion.

30. The user device of claim 28, wherein a difference between a lower edge of the first frequency portion and a lower edge of a first component carrier bandwidth is greater than or equal to a width of the first frequency portion, and wherein a difference between an upper edge of the first component carrier bandwidth and an upper edge of the first frequency portion is greater than or equal to the width of the first frequency portion, and
wherein a difference between a lower edge of the second frequency portion and a lower edge of a second component carrier bandwidth is greater than or equal to a width of the second frequency portion, and wherein a difference between an upper edge of the second component carrier bandwidth and an upper edge of the second frequency portion is greater than or equal to the width of the second frequency portion.

31. The user device of claim 28, wherein a difference between an upper edge of the first frequency portion and a lower edge of the second frequency portion is greater than or equal to a width of the first frequency portion and the second frequency portion, or wherein a difference between an upper edge of the second frequency portion and a lower edge of the first frequency portion is greater than or equal to a width of the first frequency portion and the second frequency portion.

32. The user device of claim 27, further comprising:
means for receiving, from the network device, configuration information for configuring a first uplink bandwidth part and a second uplink bandwidth part, the transmission of the first uplink reference signal being confined within the configured first uplink bandwidth part, and the transmission of the second uplink reference signal being confined within the configured second uplink bandwidth part.

33. The user device of claim 32, wherein the first and second uplink bandwidth parts are configured so as to span a minimum allowed number of physical resource blocks, and wherein the first uplink bandwidth part is configured so as to be located at a central position of a first component carrier bandwidth, and the second uplink bandwidth part is configured so as to be located at a central position of a second component carrier bandwidth.

34. The user device of claim 27, further comprising:
means for receiving, from the network device, a request for transmitting the first uplink reference signal and the second uplink reference signal without using digital pre-distortion.

35. The user device of claim 27, further comprising:
means for receiving, from the network device, a request for transmitting the first uplink reference signal, wherein the request is received responsive to a change in uplink transmit power by the user device on the first component carrier; and
means for transmitting the first uplink reference signal responsive to the request, wherein the second uplink reference signal is not transmitted based on the request.

36. The user device of claim 27, wherein the first uplink reference signal is usable for characterization at the network device of a first ACLR of the user device within the reception bandwidth, and the second uplink reference signal is usable for characterization at the network device of a second ACLR of the user device within the reception bandwidth, and wherein the user device further comprises:
means for receiving, from the network device, ACLR information derived from the characterization of the first ACLR and/or the second ACLR based on the first uplink reference signal and/or the second uplink reference signal respectively.

37. The user device of claim 27, wherein, when the first indication and/or the second indication indicates that digital pre-distortion is disabled for performance of subsequent uplink transmissions, digital pre-distortion is disabled for performance of subsequent uplink transmissions on the first component carrier and/or the second component carrier respectively as long as the subsequent uplink transmissions are performed with a transmit power value that is lower than a corresponding reference transmit power value with which the respective one of the first uplink reference signal and the second uplink reference signal is transmitted.

38. The user device of claim 27, wherein, when the first indication and/or the second indication indicates that digital pre-distortion is enabled for performance of subsequent uplink transmissions, digital pre-distortion is enabled for performance of subsequent uplink transmissions on the first component carrier and/or the second component carrier respectively as long as the subsequent uplink transmissions are performed with a transmit power value that is greater than or equal to a corresponding reference transmit power value with which the respective one of the first uplink reference signal and the second uplink reference signal is transmitted.

39. The user device of claim 27, further comprising one or more of:
means for transmitting, to the network device, information indicative of whether digital pre-distortion is currently enabled or disabled for performance of uplink transmissions on the first component carrier and/or the second component carrier by the user device; or
means for transmitting, to the network device, a request to re-determine the first indication and/or the second indication.

40. A network device comprising:
means for receiving a first uplink reference signal on a first component carrier and a second uplink reference signal on a second component carrier, the first uplink reference signal and the second uplink reference signal having been transmitted by a user device without using digital pre-distortion, wherein the first component carrier and the second component carrier form part of a reception bandwidth of the network device;
means for determining, based on the received first uplink reference signal, a first indication indicating whether digital pre-distortion is enabled or disabled for performance, by the user device, of subsequent uplink transmissions on the first component carrier;
means for determining, based on the received second uplink reference signal, a second indication indicating whether digital pre-distortion is enabled or disabled for performance, by the user device, of subsequent uplink transmissions on the second component carrier; and
means for transmitting, to the user device, the first indication and the second indication.

41. The network device of claim 40, further comprising:
means for configuring the first uplink reference signal to be transmitted over a first frequency portion of the first component carrier, wherein a location and a width of the frequency portion are tailored so as to allow the network device to characterize a first Adjacent Channel Leakage power Ratio, ACLR, of the user device within the reception bandwidth;
means for configuring the second uplink reference signal to be transmitted over a second frequency portion of the second component carrier, wherein a location and a width of the second frequency portion are tailored so as to allow the network device to characterize a second Adjacent Channel Leakage power Ratio, ACLR, of the user device within the reception bandwidth;
means for characterizing, based on the first uplink reference signal and the second uplink reference signal, the first ACLR and the second ACLR of the user device.

42. The network device of claim 40, further comprising:
means for determining configuration information for configuring a first uplink bandwidth part and a second uplink bandwidth, the transmission of the first uplink reference signal being confined within the first uplink bandwidth part, and the transmission of the second uplink reference signal being confined within the second bandwidth part; and
means for transmitting, to the user device, the configuration information.

43. The network device of claim 40, further comprising:
means for transmitting, to the user device, a request for transmitting the first uplink reference signal and the second uplink reference signal without using digital pre-distortion; and
means for receiving the first uplink reference signal and the second uplink reference signal respectively responsive to the request.

44. The network device of claim 40, further comprising:
means for transmitting, to the user device, a request for transmitting the first uplink reference signal, wherein the request is transmitted responsive to a change in uplink transmit power by the user device on the first component carrier; and
means for receiving the first uplink reference signal responsive to the request, wherein the second uplink reference signal is not received based on the request.

45. The network device of claim 40, further comprising:
means for characterizing, based on the first uplink reference signal and the second uplink reference signal, a first ACLR of the user device within the reception bandwidth and a second ACLR of the user device within the reception bandwidth; and
means for transmitting, to the user device, ACLR information derived from the characterization of the first ACLR and/or the second ACLR.

46. The network device of claim 40, wherein, when the first indication and/or the second indication indicates that digital pre-distortion is disabled for performance of subsequent uplink transmissions, the first indication and/or the second indication indicates that digital pre-distortion is disabled for performance of subsequent uplink transmissions on the first component carrier and/or the second component carrier respectively as long as the subsequent uplink transmissions are performed with a transmit power value that is lower than a corresponding reference transmit power value with which the respective one of the first uplink reference signal and the second uplink reference signal is transmitted.
